(19) United States
(12) Patent Application Publication
(10) Pub. No.: US 2022/0154518 A1
(43) Pub. Date: May 19, 2022

(54) DIRECT DRIVE CABLE-OPERATED ACTUATION SYSTEM FOR CLOSURE PANEL

(71) Applicant: Magna Closures Inc., Newmarket (CA)

(72) Inventors: Michael BAYLEY, Newmarket (CA); Steven LIU, Newmarket (CA); Ke LI, Newmarket (CA)

(21) Appl. No.: 17/439,484

(22) PCT Filed: Apr. 9, 2020
(86) PCT No.: PCT/CA2020/050468

§ 371 Date: Sep. 15, 2021

Related U.S. Application Data
(60) Provisional application No. 62/831,957, filed on Apr. 10, 2019.

(51) Int. Cl. E05F 15/695; E05F 15/697; E05F 15/659; E05F 15/662; H02K 7/10; H02K 7/102; H02K 7/116

(52) U.S. Cl. CPC E05F 15/695; B60J 5/06; E05F 15/659; E05F 15/662; H02K 7/1004; H02K 7/102; H02K 7/1166; E05Y 2201/21; E05Y 2201/232; E05Y 2201/434; E05Y 2201/64; E05Y 2201/654; E05Y 2201/664; E05Y 2201/684; E05Y 2400/20; E05Y 2400/302; E05Y 2400/32; E05Y 2900/531; E05Y 2900/55; E05F 15/697

(57) ABSTRACT

An actuation system and method of operation for moving a closure panel in one of a normal drive state and a back drive state are provided. The actuation system includes a mechanical coupling for moving the closure panel. A motor with a shaft is directly and operably connected to the mechanical coupling to directly move the mechanical coupling. A sensor detects movement of the closure panel and couples to a controller connected to the motor. The controller moves the closure panel with the motor based on a detected motor movement command in the normal drive mode. The controller also detects movement of the closure panel using the at least one sensor and selectively brakes the movement of the closure panel based on the movement detected in the back drive state.

### CROSS-REFERENCE TO RELATED APPLICATION

This PCT International Patent application claims the benefit of U.S. Provisional Application No. 62/831,957 filed Apr. 10, 2019. The entire disclosure of the above application being considered part of the disclosure of this application and hereby incorporated by reference.

### FIELD

The present disclosure relates generally to motor vehicle closure panels, and more particularly to power-operated actuation systems therefor.

### BACKGROUND

This section provides background information related to the present disclosure which is not necessarily prior art.

In many motor vehicle door assemblies, an outer sheet metal door panel and an inner sheet metal door panel are connected together to define an internal door cavity therebetween. In some motor vehicle door assemblies, such as those including power-operated windows, an equipment module or sub-assembly, commonly referred to as a carrier module, or simply carrier, is mounted to the inner door panel within the internal door cavity. The carrier typically functions to support various door hardware components, such as a window regulator rail 1 shown in FIGS. 1A and 1B, for example, configured to support lifter plate 2 for selectively slidable movement therealong, as well as an actuator system 3 configured to drive the lifter plate 2 along the window regulator rail 1. The lifter plate 2 is fixed to a window (not shown) to cause the window to slide up and down therewith along the direction of guide channels within the window regulator rail 1 in response to powered actuation of the actuator system 3.

The actuator system 3 typically includes a regulator motor 4 operably connected to a cable drum 5 via a gearbox assembly 6 (in FIG. 1B, a drum cover of the cable drum 5 is hidden for clarity). Motor 4 typically has an output shaft extending to a worm gear, with the worm gear being configured in meshed engagement with a drive gear of the gearbox assembly 6. The gearbox assembly 6 typically includes a planetary gearset with an output gear member configured in meshed engagement with an input gear of the cable drum 5. Unfortunately, the aforementioned actuator system 3 experiences inherent inefficiencies due to the gearing losses resulting from friction and slop (play) between the several intermeshed gears. As a result of the inherent operational inefficiencies, components, such as the motor 4, are often increased in power, size and weight, which inherently increases cost and decreases fuel efficiency.

In addition to motor vehicle door assemblies including power-operated windows, other motor vehicle door assemblies, such as power-operated sliding doors, can include similar types of actuator systems as discussed above for actuator system 3, in addition to clutches, to facilitate sliding movement of the power-operated sliding doors between closed and open positions. Accordingly, during powered movement of the sliding door, similar losses are typically experienced within the gearbox assembly of the actuator system, as well as in the associated clutches.

In view of the above, there is a need to provide actuation systems for motor vehicles that are efficient in operation, while at the same time being compact, robust, durable, lightweight and economical in manufacture, assembly, and in use.

### SUMMARY

This section provides a general summary of the disclosure and is not intended to be a comprehensive listing of all features, advantages, aspects and objectives associated with the inventive concepts described and illustrated in the detailed description provided herein.

It is an object of the present disclosure to provide actuation systems for a closure panel of a vehicle that address at least some of those issues discussed above with known actuation systems.

In accordance with the above object, it is an aspect of the present disclosure to provide actuation systems that are efficient in operation, while at the same time being compact, robust, durable, lightweight and economical in manufacture, assembly, and in use.

In accordance with another aspect of the disclosure, the present disclosure is directed to an actuation system for moving a closure panel of a vehicle in one of a normal drive state and a back drive state. The actuation system includes a mechanical coupling connected to the closure panel for moving the closure panel in between an open position and a closed position. The actuation system also includes a motor having a shaft directly and operably connected to the mechanical coupling and configured to directly move the mechanical coupling. The actuation system additionally includes at least one sensor for detecting movement of the closure panel. The actuation system additionally includes a controller electrically coupled to the motor and to the at least one sensor and configured to detect a motor movement command in the normal drive state. The controller is also configured to directly move the closure panel with the motor based on the motor movement command detected in the normal drive state and detect movement of the closure panel using the at least one sensor in one of the normal drive state and the back drive state. The controller controls operation of the motor based on the movement detected and the motor movement command detected in one of the normal drive state and the back drive state. The controller also selectively brakes the movement of the closure panel in between the closed position and the open position based on the movement detected in the back drive state.

In accordance with yet another aspect of the disclosure, the present disclosure is directed to a method of operating an actuation system for moving a closure panel of a vehicle in one of a normal drive state and a back drive state. The method includes the step of detecting a motor movement command using a controller in the normal drive state. Next, directly moving the closure panel in between an open position and a closed position with a motor having a shaft directly and operably connected to a mechanical coupling connected to the closure panel based on the motor movement command detected in the normal drive state. The method then includes the step of detecting movement of the closure panel using at least one sensor coupled to the motor and the controller in one of the normal drive mode and the back drive state. The method proceeds by controlling operation of the motor using the controller based on the movement detected and the motor movement command detected in one of the normal drive mode and the back drive state. The method also includes the step of selectively braking the movement of the closure panel in between the closed position and the open position based on the movement detected using the controller in the back drive state.

In accordance with yet another aspect, there is provided an actuation system for moving a closure panel of a vehicle, including a mechanical coupling connected to the closure panel for moving the closure panel in between an open position and a closed position, and a motor having a shaft directly and operably connected to the mechanical coupling and configured to directly move the mechanical coupling.

In a related aspect, a gear reduction mechanism is not interconnected between the shaft and the mechanical coupling.

In another related aspect, a clutch mechanism is not interconnected between the shaft and the mechanical coupling.

In another related aspect, the motor is a brushless motor.

In another related aspect, the shaft is interconnected to the mechanical coupling by a transmission.

In another related aspect, the transmission is a backdrivable transmission.

In another related aspect, the actuation system includes a braking system coupled to at least one of the mechanical coupling and the transmission and the motor.

In another related aspect, the braking system comprises a braking assembly configured for selectively braking the movement of the closure panel, the at least one of the mechanical coupling and the transmission and the motor.

In another related aspect, the braking system includes at least one sensor for detecting movement of at least one of the closure panel, the mechanical coupling, the transmission, and the motor; and a controller electrically coupled to the motor and to the at least one sensor and configured to detect movement of the at least one of the closure panel, the mechanical coupling, the transmission, and the motor using the at least one sensor and to selectively brake the movement of the closure panel in between the closed position and the open position based on the detected movement.

In another related aspect, the controller is configured control the motor to oppose the detected movement of the at least one of the closure panel, the mechanical coupling, the transmission, and the motor.

In another related aspect, the motor is a brushless motor and the controller is configured to control the motor using a field oriented control methodology comprising supplying a flux linkage voltage command and a torque voltage command to the motor.

In accordance with another related aspect, there is provided method of constructing an actuation system for moving a closure panel of a vehicle including the steps of providing a mechanical coupling connected to the closure panel for moving the closure panel in between an open position and a closed position; and providing a motor having a shaft directly and operably connected to the mechanical coupling and configured to directly move the mechanical coupling.

Further areas of applicability will become apparent from the description provided herein. The description and specific examples in this summary are only intended to illustrate certain non-limiting embodiments which are not intended to limit the scope of the present disclosure.

### DRAWINGS

The drawings described herein are for illustrative purposes only of selected embodiments and not all possible implementations, and are not intended to limit the scope of the present disclosure.

FIGS. 1A and 1B illustrate a prior art window regulator rail and support lifter plate movable along the window regulator rail by an actuator system;

FIG. 2 illustrates a motor vehicle with a closure panel, according to aspects of the disclosure;

FIG. 3 is an elevation view of a motor and a mechanical coupling of an actuation system, according to aspects of the disclosure;

FIG. 4 shows a front view of a motor and a mechanical coupling of the actuation system according to aspects of the disclosure;

FIGS. 5A-5B illustrate the actuation system, according to aspects of the disclosure;

FIGS. 6A-6C illustrate a plurality configurations of the controller, motor, and mechanical coupling of the actuation system, according to aspects of the disclosure;

FIGS. 7A-7D illustrate additional configurations of the controller, motor, and mechanical coupling of the actuation system to additionally allow for braking of the actuation system, according to aspects of the disclosure;

FIGS. 8, 9, and 10 show an electromechanical brake assembly of the actuation system, according to aspects of the disclosure;

FIG. 11 is a diagrammatic view of a brushless direct current motor and a control system of the actuation system for implementing field oriented control, according to aspects of the disclosure;

FIG. 12 is a schematic representation of operating zones of the brushless direct current motor, according to aspects of the disclosure;

FIG. 13 shows plots of phase shifted 3-axis stator system electrical quantities of currents driving the brushless direct current motor, according to aspects of the disclosure;

FIG. 14 illustrates a stator current vector decomposed into a 2-axis reference frame quadrature current and flux current components, according to aspects of the disclosure;

FIG. 15 is a diagrammatic view of the stator and rotor of a brushless motor illustrating the rotor magnetic field and the stator magnetic field, and quadrature and stator forces acting on the rotor, according to aspects of the disclosure;

FIG. 16 is a 3-axis representation of the 2-axis transformed stator current vector of FIG. 14, illustrating the delta between the stator current vector and the quadrature axis of the rotor, according to aspects of the disclosure;

FIG. 17 is a block diagram of aspects of the control system of FIG. 11, according to aspects of the disclosure;

FIG. 18 illustrates a block diagram of aspects of the control system of FIG. 15, showing the resultant changes in quadrature and flux current components, according to aspects of the disclosure;

FIGS. 19A-19C show the motor during compensation by the actuation system for a small manual input movement, according to aspects of the disclosure;

FIGS. 20A-20C show the motor and aspects of the control system of FIG. 15 during compensation by the actuation system for an increased manual input movement, according to aspects of the disclosure;

FIGS. 21A-21B show the motor and aspects of the control system of FIG. 17 during holding by the actuation system after the rotor of the brushless direct current motor has been moved back to an initial position, according to aspects of the disclosure; and

FIGS. 22-25 illustrate steps of a method of operating the actuation system for moving the closure panel of a vehicle in one of a normal drive state and a back drive state, according to aspects of the disclosure.

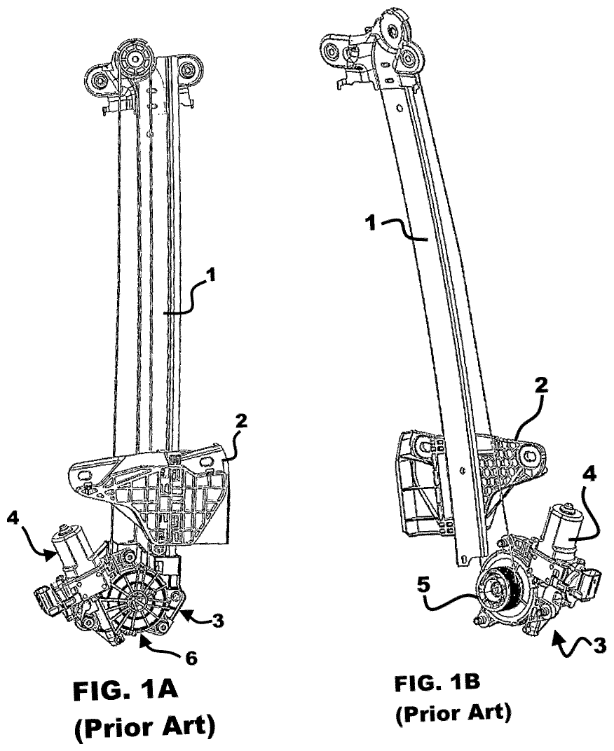

### DETAILED DESCRIPTION

The expression “closure panel” will be used, in the following description and the accompanying claims, to generally indicate any element movable between an open position and a closed position, respectively opening and closing an access to an inner compartment of a motor vehicle, therefore including, but not limited to boot, doors, liftgates, sliding doors, rear hatches, bonnet lid or other closed compartments, windows, sunroofs, in addition to the side doors of a motor vehicle.

In general, the present disclosure relates to an actuation system of the type well-suited for use in many applications. The actuation system and associated methods of operation of this disclosure will be described in conjunction with one or more example embodiments. However, the specific example embodiments disclosed are merely provided to describe the inventive concepts, features, advantages and objectives with sufficient clarity to permit those skilled in this art to understand and practice the disclosure. Specifically, the example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

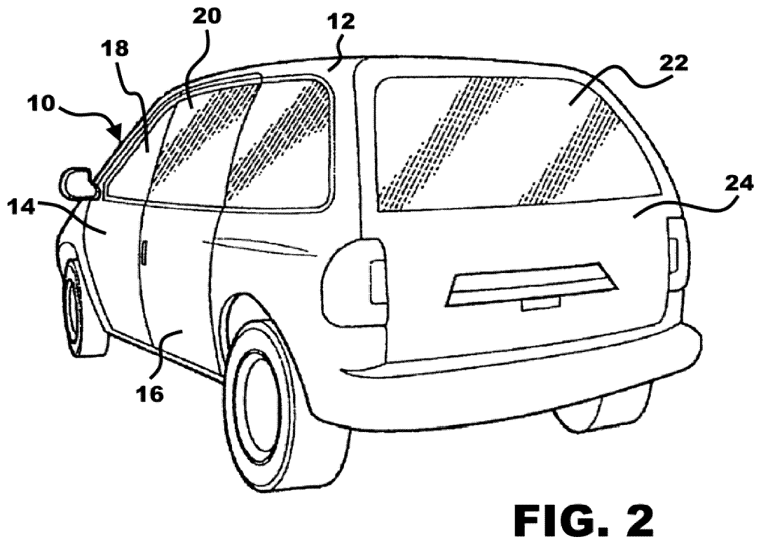

Now referring to FIG. 2 of the drawings, an example of a motor vehicle 10 is shown having a vehicle body 12, a hinged front door 14 and a sliding rear door 16. Front door 14 is equipped with a window 18 which is moveable between closed and open positions via a power-operated window lift system. Similarly, rear door 16 is equipped with a window 20 which is moveable between closed and open positions via a power-operated window lift system. While the present disclosure will hereinafter be specifically directed to describing the window lift system associated with a door 16, those skilled in the art will recognize and appreciate that similar arrangements to that described herein can be adapted for use with front door 14 and/or a window 22 associated with a hinged liftgate 24, as well as any other type of closure panel, such as sliding doors, sunroofs and the like, and as well as other vehicle power actuators, such as for power release, power lock in vehicle door latches, as well as for cinching actuators, and the like.

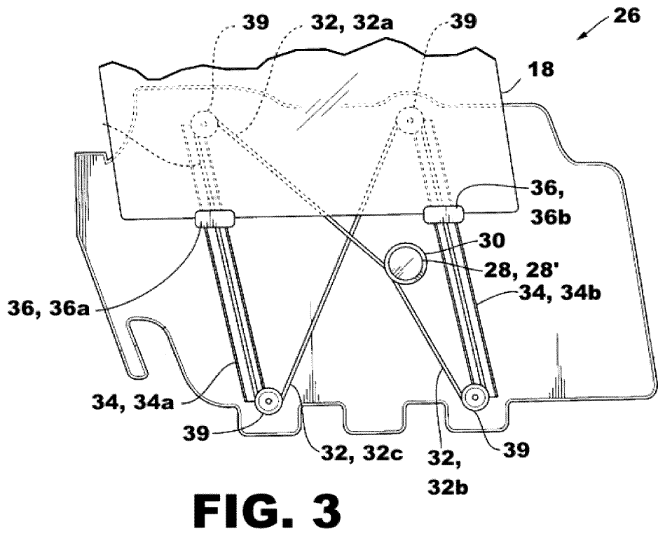

FIG. 3 shows a window regulator 26 of an actuation system 27 for moving the window 20 in vehicle door 16, in accordance with aspects of the disclosure. The window regulator 26 includes a motor 28, 28′, a drum 30, a set of three drive cables 32, shown individually at 32a, 32b and 32c, two rails 34 shown individually at 34a and 34b, two lifter plates 36, shown individually at 36a and 36b.

The rails 34 may be mounted in any suitable way to the vehicle door 16. For example the rails 34 may be mounted to a carrier panel 38 that is inside the vehicle door 16. The lifter plates 36 hold the window 20 and are slidably mounted on the rails 34. The cable 32a connects between the drum 30 around a pulley 39 at an end of rail 34a and the first lifter plate 36a. The cable 32b connects between the drum 30 around a pulley at an end of rail 34b and the second lifter plate 36b. The cable 32c is mounted between the two lifter plates 36 and wraps around pulleys 39 at ends of both rails 34. The lifter plates 36 are driven upwardly and downwardly via the cables 32, which are themselves driven by rotation of the drum 30. The drum 30 is rotated in a first direction or a second opposite direction by the motor 28, 28′ depending on whether the occupant of the vehicle 10 wishes the window 18 to be raised or lowered. The motor 28, 28′ may be a bidirectional electric motor.

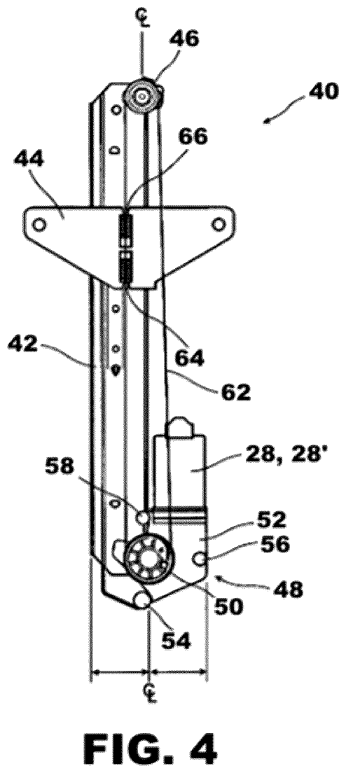

According to another aspect, best shown in FIG. 4, the actuation system 27 may utilize or comprise a single rail window regulator 40. Regulator 40 includes a rail 42 along at least a portion of the length of which a lifter plate 44 can slide. A guide, in the illustrated embodiment a pulley 46, is mounted adjacent one end of rail 42. At the end of rail 42 opposite pulley 46, a drive means 48 is located, drive means 48 comprising motor 28, 28′ (e.g., direct current motor) and a driven drum 50 which can be turned in a clockwise or counter clockwise direction by operation of motor 28, 28′ in a respective direction.

Driven drum 50 can be connected to motor 28, 28′ by any suitable means, such as a gear train and/or a clutch mechanism, as will be apparent to those of skill in the art and a housing 52 encloses the gear train and/or clutch mechanism and includes three bores in or through which mounting bolts 54, 56 and 58 can be received. Bolt 58 extends through rail 42 to pivotally connect drive means 48 to rail 42. Bolt 56 can be employed to assist in mounting regulator 40 within the vehicle 10 and bolt 54 can engage a slot in the end of rail 42, to prevent further pivotal movement of drive means 48 with respect to rail 42 once regulator 40 is assembled.

A flexible drive member 62 extends from a first attachment point 64 on lift plate 44 down to driven drum 50 about which it is wrapped and then up to and around pulley 46 and then down to a second attachment point 66 on lifter plate 44. As shown, flexible drive member 62 is a wire cable. Configurations of driven drum 50 and pulley 46 which are suitable for other flexible drive member 62, such as belts, will be apparent to those of skill in the art. Further, rather than a pulley 46, the guide for flexible drive member 62 can be any suitable device about which flexible drive member 62 can move. Suitable guides for wire cables 62 can include a Delrin™ disc with grooves in its perimeter edge, the wire cable 62 sliding through the groove around the perimeter of the disc when the wire cable 62 is moved.

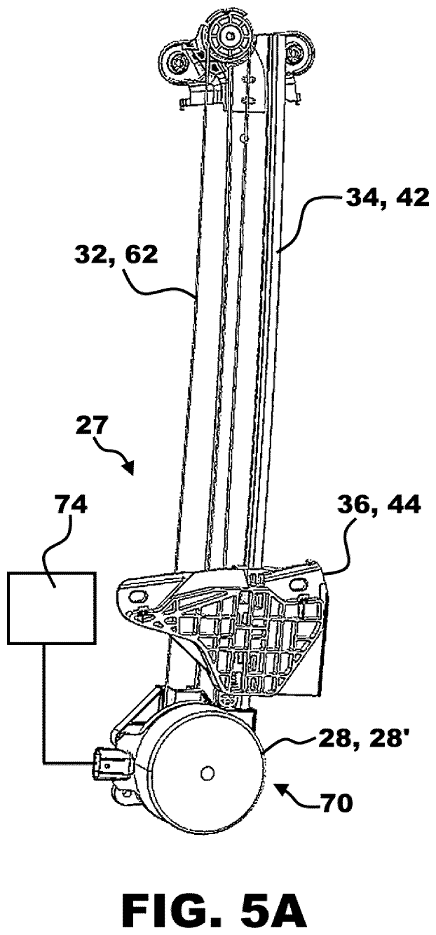

As best shown in FIGS. 5A-5B, the actuation system 27 for moving a closure panel (e.g., window 20) of the vehicle 10 in one of a normal drive state and a back drive state is provided according to other aspects of the disclosure. The actuation system 27 includes a mechanical coupling 70 connected to the closure panel (e.g., window 20) for moving the closure panel 20 in between an open position and a closed position. Other types of mechanical couplings 70 may be provided such as a center hinge or sliding door bracket as described in U.S. Pat. No. 7,770,961 entitled “Compact cable drive power sliding door mechanism”, the entire contents of which are incorporated herein by reference.

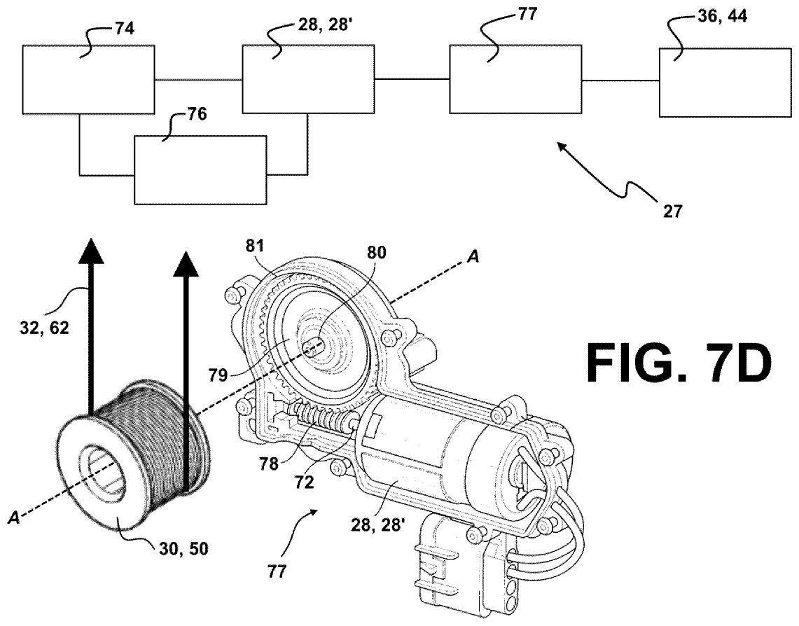

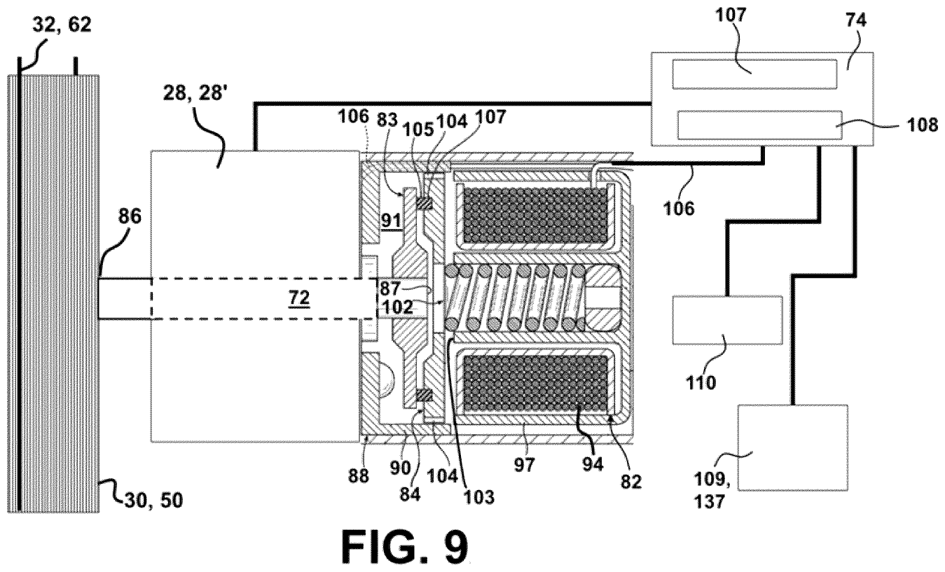

The actuation system 27 also includes the motor 28, 28′ having a shaft 72 directly and operably connected to the mechanical coupling 70 and configured to directly move the mechanical coupling 70. So, the mechanical coupling 70 can be the drum 30, 50 directly connected to the shaft 72 (the drum 30, 50 is shown with a drum cover hidden for clarity in FIG. 5B). In addition, the actuation system 27 includes a controller 74 electrically coupled to the motor 28, 28′ and to at least one sensor 114a, 114b, 114c (FIG. 11). The controller 74 is configured to detect a motor movement command in the normal drive state (e.g. from a switch 109 or a signal from a body control module/BCM 137 in FIGS. 9A-9B) and directly move the closure panel 20 with the motor 28, 28′ based on the motor movement command detected in the normal state. The controller 74 also detects movement of the closure panel 20 using the at least one sensor 114a, 114b, 114c in one of the normal drive mode and the back drive state. The controller 74 additionally controls operation of the motor 28, 28′ based on the movement detected and the motor movement command detected in one of the normal drive state and the back drive state. The controller 74 is also configured to selectively brake the movement of the closure panel 20 in between the closed position and the open position based on the movement detected using the controller 74 in the back drive state. The controller 74 also detects movement of the closure panel 20 using other types of sensor configurations, such as for detecting directly the movement of the window 20, or movement of any component in the transmission between the window 20 and the motor 28, 28′.

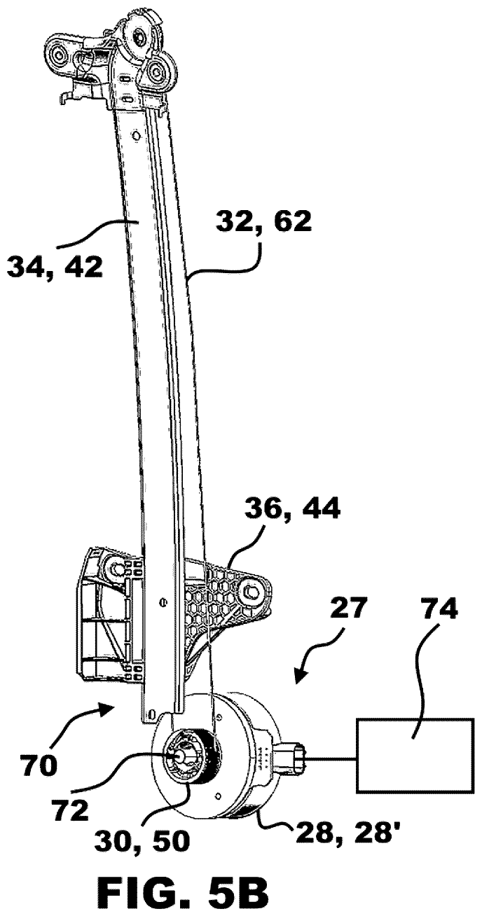

As best shown in the block diagrams of FIG. 6A-6C, a plurality configurations of the controller 74, motor 28, 28′, and mechanical coupling 70 of the actuation system 27 may be utilized to directly drive the closure panel 20. Referring to FIG. 6A, the closure panel is a window 20 of the door 16. The motor 28, 28′ is a brushed electrical motor 28 and the mechanical coupling 70 includes a direct drive or direct mechanical connection between the shaft 72 of the motor 28 and a lifter plate 36, 44 of the window regulator 40. Thus, because no gear train is utilized, efficiency of the actuation system 27 can be improved; however, it is still possible to back drive the actuation system 27. In the case of the window 20, for example, it may be undesirable to allow back drive, as the security of a closed window 20 could be compromised by window 20 being forced back or back driven into the door 16 or body of the vehicle 10. The actuation system 27 of FIG. 6B is similar to that shown in FIG. 6A; yet, instead of a brushed electric motor 28, the actuation system 27 shown utilizes a brushless direct current motor 28′. Thus, the back drive can be countered or corrected by control of the brushless direct current electric motor 28′. In, FIG. 6C, another exemplary actuation system 27 is shown. Again, the closure panel is the window 20 of the door 16. The mechanical coupling 70 includes a rail 34,42 for coupling to the door 16 and a lifter plate 36,44 is attached to the window 20 and slidably mounted on the rail 34,42. A cable 32, 62 attaches to the lifter plate 36, 44. A drum 30, 50 is directly coupled to the shaft 72 of the motor 28, 28′ with the cable 32,62 looped about the drum 30,50 for moving the cable 32, 62 and the lifter plate 36, 44 along the rail in response to rotation of the shaft 72 of the motor 28, 28′. Thus, as in FIGS. 6A and 6B, there is no gear train, as the drum 30, 50 is directly coupled to the shaft 72 of the motor 28, 28′. Again, in FIG. 6C, the motor 28, 28′ is a brushless direct current electric motor 28′. It should be understood that although one is not shown in FIG. 6C, a planetary gear train may be utilized as part of the mechanical coupling 70.

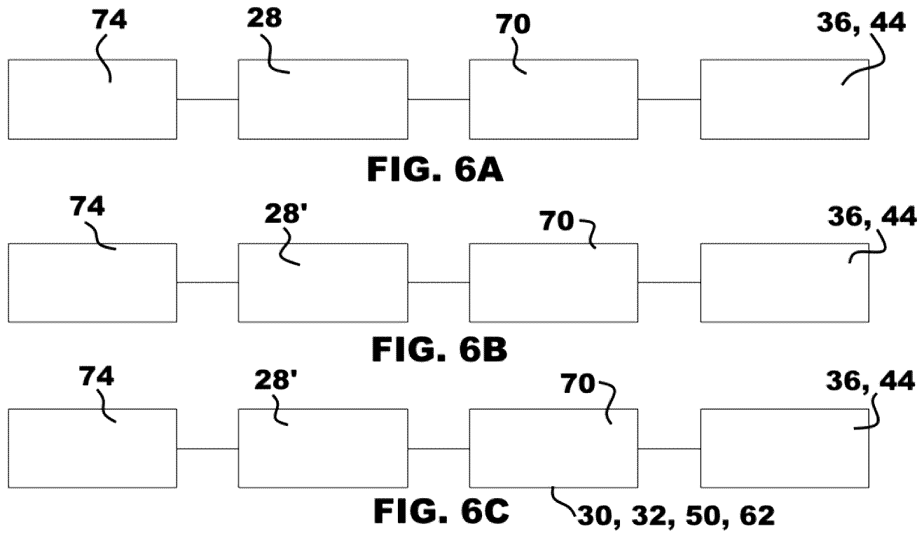

Now referring to FIGS. 7A-7D, additional configurations of the controller 74, motor 28, 28′, and mechanical coupling 70 of the actuation system 27 are provided to additionally allow for braking or resistance to movement of the mechanical coupling 70, motor 28, 28′, and/or closure panel 20. Referring to FIG. 7A, the closure panel is the window 20 of the door 16 and the mechanical coupling 70 includes a rail for coupling to the door 16, a cable 32, 62 directly driven by the shaft 72 of the motor 28, 28′, and a lifter plate 36, 44. The lifter plate 36, 44 is attached to the window 20 and slidably mounted on the rail and configured to lock the lifter plate 36, 44 at any position along the rail when the motor 28, 28′ is not operated and the cable 32, 62 is not tensioned by the motor 28, 28′. The lifter plate 36, 44 also enables motion of the lifter plate 36, 44 when the motor 28, 28′ is operated and the cable 32, 62 is tensioned by the motor 28, 28′. In other words, the lifter plate 36, 44 in FIG. 7A is a locking lifter plate such as in U.S. Pat. No. 7,975,434, incorporated herein by reference. Consequently, back drive is prevented by the locking of the lifter plate 36, 44.

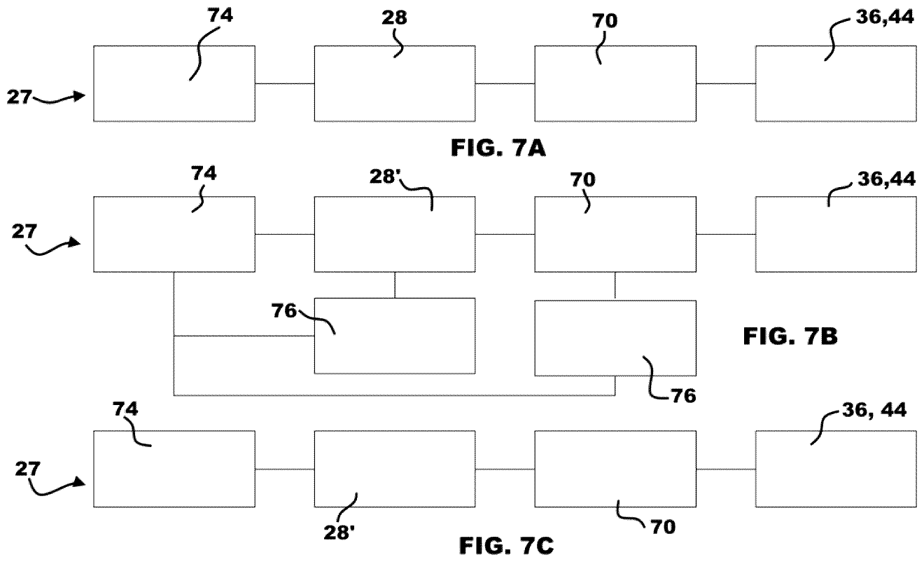

In FIG. 7B, the motor 28, 28′ is a brushless direct current electric motor 28′ and the mechanical coupling 70 includes a direct mechanical connection between the shaft 72 of the motor 28, 28′ and the lifter plate 36, 44 of the window 20. However, as shown, the actuation system 27 can additionally include a clutch or electromechanical brake assembly 76 (FIGS. 8, 9A, and 9B) coupled to at least one of the mechanical coupling 70 and the motor 28, 28′ (both couplings are shown). The electromechanical brake assembly 76 is electrically coupled to and controlled by the controller 74 to selectively move between an engaged status and a disengaged status. The electromechanical brake assembly 76 is, for example, set to be in the engaged status by default in case of a power loss and the brake is removed (i.e., moved to the disengaged status) only when the motor 28′ is driven. In the engaged status, rotation of the shaft 72 is hindered for braking movement of the mechanical coupling 70 and the closure panel 20 between the closed position and the open position in the back drive state. In contrast, in the disengaged status, the shaft 72 is permitted to rotate and allow movement of the mechanical coupling 70 and the closure panel 20 in the normal drive state. So, to prevent back drive, locking or braking is achieved using the electromechanical brake assembly 76.

FIG. 7C does not include an electromechanical brake assembly 76 like in FIG. 7B; nevertheless, locking or braking is achieved by applying power to the motor 28, 28′ to stop rotation of the shaft 72 of the motor 28, 28′ and as a result, stop motion of the mechanical coupling 70 and closure panel 20. Specifically, the motor 28, 28′ is a brushless direct current electric motor 28′ and the mechanical coupling 70 includes a direct mechanical connection between the shaft 72 of the motor 28′ and the lifter plate 36, 44 of the window 20. Thus, the brushless electric motor 28′ is capable of braking control (i.e., opposing the closure panel or window 20 from being back driven), one example of a braking system, and specifically one example of an electronic braking system.

FIG. 7D illustrates a configuration of the actuation system 27 in which the mechanical coupling 70 includes a rail 34, 42 for coupling to the door 16 and a lifter plate 36, 44 attached to the window 20 and slidably mounted on the rail. A cable 32, 62 attaches to the lifter plate 36, 44. The mechanical coupling 70 also includes a transmission, for example gear train 77 being back drivable and having a gear train input driven by the shaft 72 of the motor 28, 28′ and a gear train output. A drum 30, 50 is coupled to the gear train output with the cable 32, 62 looped thereabout for moving the cable 32, 62 and the lifter plate 36, 44 along the rail 34, 42 in response to rotation of the shaft 72 of the motor 28, 28′ as modified by the gear train 77. The gear train 77 can for example be a gear train 77 such as in U.S. Pat. No. 9,234,377, herein incorporated by reference. Specifically, the gear train 77 can include a worm gear 78 attached to the shaft 72 of the motor 28, 28′ at the gear train input and a spur gear 79 attaches to a gear shaft 80 comprising the gear train output and having a plurality of outer peripheral teeth 81 in meshed engagement with the worm gear 78. Such a gear train or transmission as a gear reduction mechanism may have gear reduction properties whereby the speed of the motor is reduced at the output of the transmission for providing speed reduction/torque multiplication. Rotation of the worm gear 78 by the motor 28, 28′ causes rotation of the spur gear 79 in the normal drive state and rotation of the spur gear 79 causes rotation of the worm gear 78 in the back drive state. According to an aspect, the worm gear 78 is formed of brass and the spur gear 79 is formed of plastic to achieve a coefficient friction sufficient to allow back driving in which rotation of the spur gear 79 causes rotation of the worm gear 78. According to another aspect, a gear ratio between the worm gear 78 and the spur gear 79 is at least 50:1 (e.g., 57:1) to allow the worm gear 78 to be back driven by the spur gear 79 in the back drive state illustrative as one type of a backdriveable transmission. Nevertheless, it should be appreciated that other gear trains (e.g., other high efficiency, low gear ratio backdriveable gear trains) may be utilized in addition to or instead.

As best shown in FIGS. 8, 9A, and 9B, the electromechanical brake assembly 76, another example of a braking system and specifically an example of a mechanical braking system, includes a coil assembly 82 operably connected to the controller 74 for receiving electrical current. In more detail, the electromechanical brake assembly 76 remains in the engaged status when the coil assembly 82 is de-energized by the absence of the electrical current and remains in the disengaged status when the coil assembly 82 is energized by the electrical current. The electromechanical brake assembly 76 also includes a first friction plate 83 fixed for conjoint rotation with the shaft 72 and a second friction plate 84. The first and second friction plates 83, 84 are biased into frictional engagement with one another when the coil assembly 82 is de-energized. In more detail, a spring member 85 biases the first and second friction plates 83, 84 into frictional engagement with one another when the coil assembly 82 is de-energized. When the coil assembly 82 is energized, the first and second friction plates 83, 84 are moved out of frictional engagement with one another by a magnetic force from the coil assembly 82. The shaft 72 of the motor 28, 28′ extends axially through the motor 28, 28′ from a first end 86 attached to the mechanical coupling 70 (e.g., drum 30, 50) to a second end 87 attached to the first friction plate 83 of the electromechanical brake assembly 76.

As best shown in the exploded view of FIG. 8, the electromechanical brake assembly 76 includes a brake housing 88 having an end mount face 89 and an annular outer wall 90, shown as being generally cylindrical and bounding an inner cavity 91 sized for substantial receipt of various components of the brake assembly 76. To facilitate fixing the brake assembly 76 in position, the end mount face 89 is shown having a plurality of through openings 92 for receipt of fasteners therethrough, wherein the fasteners can be provided as threaded fasteners for threaded receipt into an end of the motor 28, 28′ (FIGS. 9A-9B), by way of example and without limitation. The brake assembly 76 further includes a spacer 93, also referred to as a shim. The electromagnetic coil assembly 82 has a conductive electrical wire 94 spirally wound about a bobbin 95 and configured in operable electrical communication with a source of electric current; and a coil housing 96.

The coil housing 96 has an annular outer wall 97 and a central, tubular post 98 extending along the axis A from an end wall 99 to a free end, with a toroid-shaped cavity 100 extending between the wall 97 and post 98 for receipt of the coil assembly 82 therein. The bobbin 95 of the coil assembly 82 has a through opening or passage 101 sized for close receipt about an outer surface of the post 98 and is sized for close receipt within the cavity 100 of the coil housing 96.

As best shown in FIGS. 9A and 9B, there is a direct mechanical coupling between the shaft 72 and the drum 30, 50. The spacer 93 is disposed in a cavity or pocket 102 bounded by the wall of the tubular post 98, such that the spacer 93 is brought into abutment with the end wall 99. The spring member 85 is disposed in the pocket 102 against the spacer 93, wherein the spring member 85 has a length sufficient to extend axially along the axis A (FIG. 8) outwardly from and beyond a free end 103 of the tubular post 98 while in an unbiased, axially decompressed state. It should be recognized that the spacer 93 can be provided with the desired axial thickness to adjust the force of the spring member 85 applied to the second friction plate 83 by adjusting how far the spring member 85 extends axially beyond the free end 103 of the post 98, in addition to adjusting the spring constant of the spring member 85. With the brake housing 88 fixed to the motor 28, 28′, the first friction plate 83 is operably connected for fixed attached to the second end 87 of the shaft 72 of the motor 28, 28′ for conjoint rotation therewith, such as via a press fit, bonded and/or fixed thereto via a mechanical fastener, by way of example and without limitation, while the first end 86 of the shaft 72 is operably fixedly coupled with the drum 30, 50. The second friction plate 84 is disposed in the brake housing 88 between the first friction plate 73 and the spring member 85, such that the spring member 85 engages the second friction plate 84 and forcibly biases the second friction plate 84 into contact with the first friction plate 83 upon completing assembly, and while in the “on position” or “engaged status.” The second friction plate 84 is not provided for rotation movement about the axis A, but rather, for sliding movement along the axis A during movement between the “engaged” and “disengaged” statuses. To facilitate smooth sliding movement, the second friction plate 84 is shown as having a plurality of radially outwardly extending tabs or ears 104 for close sliding engagement with an inner surface of the brake housing outer wall 90. To facilitate establishing high frictional engagement between the first and second friction plates 83, 84 while in the “engaged status,” the second friction plate 84 is shown as having a high coefficient friction material formed in shaped of an annular band 105 fixed within an annular groove 107 in an end face of the second friction plate 84. Accordingly, the annular band 105 extends axially outwardly from the end face of the second friction plate 84 for frictional engagement with an end face of the first friction plate 83 while in the “engaged status.” It should be recognized that the band 105 could be fixed to the first friction plate 83, or to both the first and second friction plates 83, 84, as desired to obtain the degree of frictional engagement therebetween. It should also be recognized that any suitable high friction coefficient material can be used for the band 105, and further, that the end faces of the first friction plate 83 and/or the second friction plate 84 can be surface treated or otherwise roughened, as desired, to facilitate providing a high degree of friction therebetween for holding the first friction plate 83 and preventing the first friction plate 83 from rotating while in the “engaged status.” One skilled in the art of braking surfaces will readily appreciate numerous mechanisms for obtaining a brake condition between the first and second friction plates 83, 84 upon viewing the disclosure herein, with those mechanisms being contemplated and incorporated herein by reference.

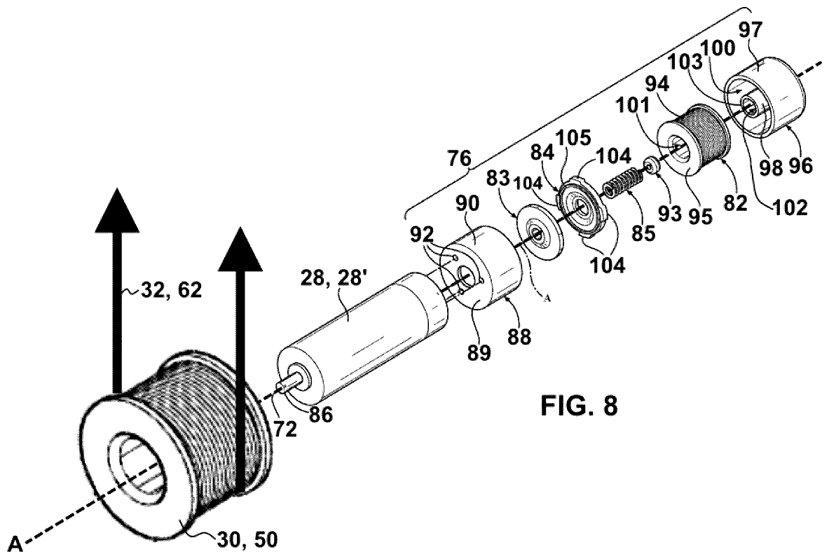

Still referring to FIGS. 9-10, an electrical lead 106 extends from the controller 74 into electrical communication with the electromechanical brake assembly 76, and in particular, with the coil assembly 82 of the electromechanical brake assembly 76. When the brake 76 is energized via electrical current, the brake 76 is moved to the “disengaged status,” and the shaft 72 can rotate about the axis A. However, the brake 76 is normally in the “engaged status” to prevent movement of the shaft 72, the mechanical coupling 70, and thus the closure panel 20.

When the electromechanical brake 76 is in the “engaged status,” as shown in FIG. 9, such as when the window 20 is fully closed, for example, the coil assembly 82 is de-energized by the absence of electrical current supplied thereto. As such, no current or energy is provided from the controller 74 to the coil assembly 82 of the brake 76, and thus the spring force imparted by the spring member 85 biases the second friction plate 84 into frictional contact with the first friction plate 83 to prevent the first friction plate 83, and thus the shaft 72, from rotating about the axis A. By preventing rotation of the shaft 72, the brake 76 also prevents movement of the mechanical coupling 70. Accordingly, the window 20 or other closure panel 20 remains closed.

To disengage the brake 76 and move the brake 76 from the “engaged status” to the “disengaged status,” a signal or command is selectively sent to controller 74. A user of the vehicle 10 can initiate sending a signal or command to the controller 74 to selectively release the brake 76, and thus allow the closure panel 20 to be freely moved to a new position, for example to an open or closed position. A switch, key fob, button, sensor, or any other device in the vehicle 10 or associated with the vehicle 10 can be used to send the signal to the controller 74. Upon receiving the signal, the controller 74 provides energy in the form of electrical current to the coil assembly 82 and also to the motor 28, 28′. Upon energizing the electromagnetic coil assembly 82 via electrical current flowing through the wire winding 94, a magnetic field is produced as a result of Ampere's law. The magnetic field exerts a magnetic force on the second friction plate 84, which is sufficiently strong to overcome the spring force of the spring member 85, and thus the magnetic force pulls and slides the second friction plate 84 axially away from and out of contact from the first friction plate 83. With the second friction plate 84 being axially spaced from the first friction plate 83 (FIG. 10), the brake 76 is brought to the “disengaged status,” thereby allowing the first friction plate 78, the shaft 72, the mechanical coupling 70 to move under a suitable externally applied force. As such, once the second friction plate 84 is disengaged from the first friction plate 83, the energy commanded by the controller 74 and provided to the motor 28, 28′ causes the shaft 72 and the first friction plate 83 to rotate about the axis A. With the second friction plate 84 no longer being in contact with the first friction plate 83, the shaft 72 and first friction plate 83 are able to rotate freely about the axis A. The shaft 72 thusly drives the mechanical coupling 70. Once the closure panel 20 reaches the closed, or another predetermined position, a signal is selectively sent from controller 74 to cease the supply of the energy to the motor 28, 28′ and the coil assembly 82, thereby de-energizing the coil assembly 82, and thus causing the magnetic force from the coil assembly 82 to dissipate, thereby causing the second friction plate 84 to move under the bias of the spring member 85 into frictional engagement with the first friction plate 83. Accordingly, the brake 76 is again brought to the “engaged status” to prevent rotation of the shaft 72 of the motor 28, 28′ and thus maintain the closure panel 20 in the desired position.

The controller 74 includes a motor control circuit 107 configured to control the motor 28, 28′ and a brake control circuit 108 configured to control the electromechanical brake 76. In addition, the switch 109 (e.g., a window regulator switch) and/or BCM 137 are shown to provide the motor movement command to the controller 74 (e.g., in the normal drive state).

The actuation system 27 of the present disclosure can also be operated manually. If manual operation is performed, the controller 74 may sense movement from the at least one sensor 114a, 114b, 114c provided for the motor 28, 28′ and releases the electromechanical brake 76 in the same manner as the power operation described above. If all power is lost, for example if the vehicle batteries are dead, then the braking torque is limited to a maximum allowing a slip condition. This will allow the closure panel 20 to be opened or closed with higher than normal manual forces. Furthermore, the controller 74 is further configured to monitor the availability of a main power source 110 and operate in one of the normal drive state and the back drive state accordingly. If the main power source 110 is normal (i.e., nota low battery or no battery condition), the electromechanical brake assembly 76 is off (power applied) when the motor 28, 28′ is on (power applied). Also, if the main power source 110 is normal, the electromechanical brake assembly 76 is on (power removed) when the motor 28, 28′ is off (power removed). However, if the main power source 110 is not normal (i.e., a low battery or no battery condition), the electromechanical brake assembly 76 is on (power removed, spring) when the motor 28, 28′ is off (power removed)

As discussed above with reference to FIG. 7C, the motor 28, 28′ can brake, resist, or stop movement of the mechanical coupling 70 and closure panel 20 in the back drive state. To provide such operation, the motor 28, 28′ is a brushless direct current electric motor 28′ and the controller 74 is configured to provide field oriented control (FOC) methodology, discussed in more detail below.

As schematically shown in FIG. 11, the brushless DC (Direct Current) electric motor 28′ or simply brushless electric motor 28′ includes a number of stator windings 112a, 112b, 112c (three in the example, connected in a star configuration), and a rotor 113, having two poles (‘N’ or North and CS' or South) in the example, which is operable to rotate with respect to the stator windings 112a, 112b, 112c. The rotation of the rotor 113, which may be connected to an output shaft (e.g., shaft 72), which is in operable communication with the mechanical coupling 70 or other mechanism or transmission for imparting a movement to the closure panel 20, such as window 20 as illustrated in FIG. 2.

Control of the brushless electric motor 28′ envisages electrical periodical switching of the generated currents Ia, Ib, Ic flowing in the stator windings 112a, 112b, 112c as energized by a DC power source e.g. main power source 110 in electrical communication with the windings 112a, 112b, 112c, in order to maintain the rotation of the rotor 113 via the resulting magnetic interaction. For example, a controller unit 111 of the actuation system 27 includes the controller 74 (e.g., microprocessor 133), a three-phase inverter 134, and a PWM (Pulse Width Modulation) unit 135 including PWM drivers 135a, coupled to the phase stator windings 112a, 112b, 112c. In a known manner, here not discussed in detail, the three-phase inverter 134 includes three pairs of power transistor switches 136 for each stator winding 112a, 112b, 112c, which are controlled by the PWM unit 135 so as to drive the respective phase voltages either at a high (ON) or a low (OFF) value, in order to control the average value of related voltages/currents energizing the stator windings 112a, 112b, 112c. When the stator windings 112a, 112b, 112c are energized in a sequential order and magnitude, as determined by the microprocessor 133 controlling the PWM unit 135, a moving magnetic flux is generated which shifts clockwise or counterclockwise. This moving magnetic flux interacts with the magnetic flux generated by the permanent magnetic rotor 113 to cause the rotor 113 to rotate. The rotational torque acting on the rotor 113 will impart a movement of the shaft 72.

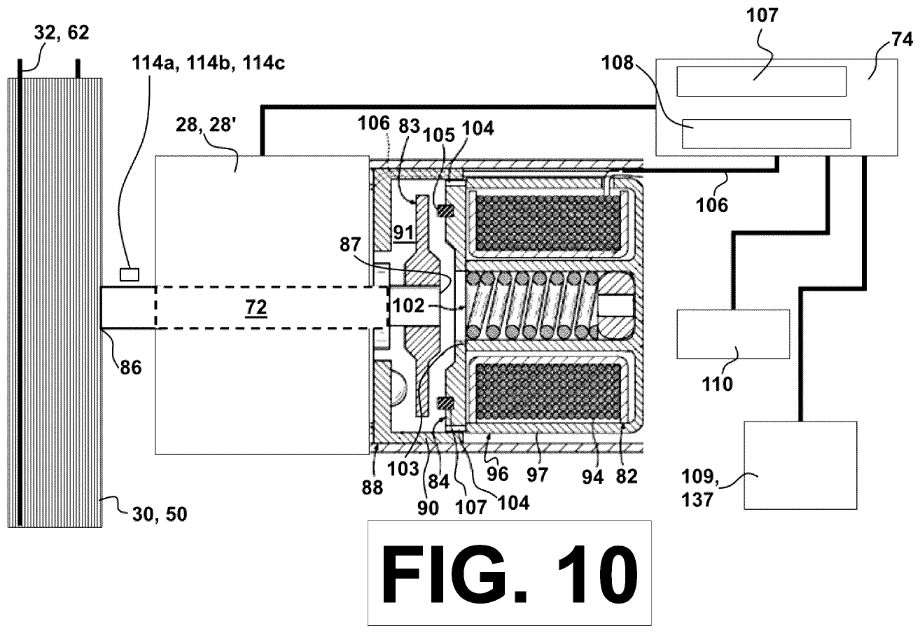

The control action may utilize knowledge of the position of the rotor 113, during its rotation in order to control the energizing voltage/current pattern to be applied to the windings 112a, 112b, 112c, also known as commutation. Accordingly, the actuation system 27 can include the at least one sensor (e.g., Hall effect sensor 114a, 114b, 114c) coupled to the motor 28, 28′ for detecting movement of the motor 28, 28′ and consequently the closure panel 20, shown schematically as 114a, 114b, 114c, are circumferentially arranged with respect to the stator windings 112a, 112b, 112c (e.g., with an angular distance of 120° of separation between them), in order to detect the position of the rotor 113, and electrically communicate the detected signals to the controller 74 via the electrical lines 117a, 117b, 117c. For example, using three on/off Hall position sensors 114a, 114b, 114c, the magnetic position of the rotor 113 may be detected for six different radial zones, and in particular at precise position of the rotor 113, as schematically shown in FIG. 12 (where the different codes corresponding to the outputs provided by the position sensors 114a, 114b, 114c are shown for each zone). Other numbers of Hall position sensors may be provided. The commutation sequence is determined by the controller 74 based on the relative positions of stator 115 and rotor 113, as measured by the either Hall-effect position sensors 114a, 114b, 114c or a magnitude of the back electromagnetic force (EMF) generated as the rotor 113 rotates as part of a sensor-less position detection technique. The control action may alternative utilize knowledge of the position of the window 20, lifterplates 36, cable drum 30, or other components moved as a result of the rotation of the rotor 113. Also in lieu of hall sensors 114a, 114b, 114c, one or more resolvers 131 (FIG. 11) may be utilized for determining the position of the rotor 113 (e.g., mounted to shaft 72). Resolvers 131, for example, provide more accuracy and consequently less movement of the rotor 113 (e.g., due to the movement of the window 20) would lead to a triggering of the braking.

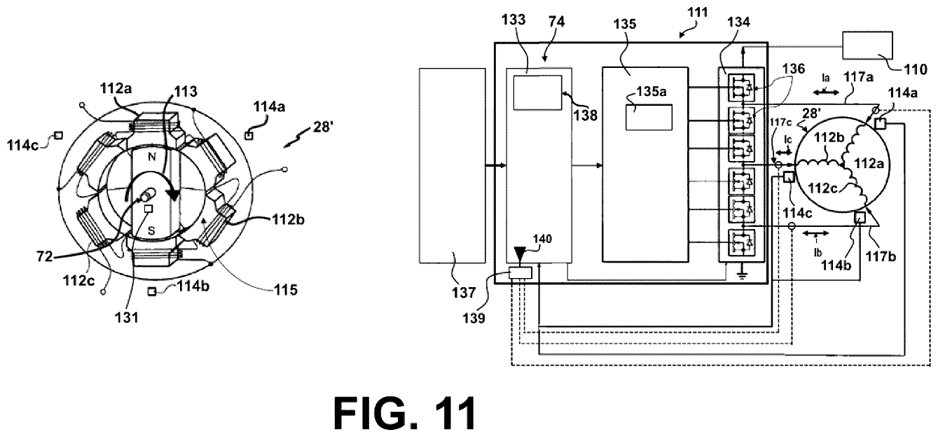

Now referring to FIG. 13 in addition to FIGS. 11 and 12, control of the brushless electric motor 28′ may be implemented in a sinusoidal drive mode, whereby the brushless electric motor 28′ is supplied by three-phase pulse width modulation (PWM) voltages modulated to obtain phase currents Ia, Ib, Ic of a sinusoidal shape in the stator windings 112a, 112b, 112c, or coils, as schematically shown. With this sinusoidal commutation, all three electrical lines 117a, 117b, 117c connected with the stator windings 112a, 112b, 112c and the PWM Unit 135, are energized (e.g., permanently) with sinusoidal currents Ia, Ib, Ic, that are 120 degrees out of phase with each other. The resulting effect of the supplied current through the stator windings 112a, 112b, 112c is the generating of a North/South magnetic field that rotates inside the motor stator 115 as the currents Ia, Ib, Ic are varied. The commutation process of switching the current flowing through the stator windings 112a, 112b, 112c, is calculated by the controller 74 controlling the PWM unit 135 (MOSFETs 136).

A memory unit 138 may be included as part of controller 74 (i.e., microprocessor 133) for storing instructions and algorithms (e.g., code) for execution by the controller 74 of the motor control methods and techniques as described herein. While memory chip 138 is shown as part of the controller 74, it could instead be separate. Instructions and code stored on the memory module 138 may also be related to various system modules, for example application programming interfaces (API) modules, drive API, digital input output API, Diagnostic API, Communication API, and communication drivers for LIN communications and CAN bus communications with the BCM 137 or other vehicle system. While modules may be described as being loaded into the memory unit 138, it is understood that the modules could be implemented in hardware and/or software.

The instructions and algorithms (e.g., code) for execution by the controller 74 of the motor control methods and techniques as described herein may relate to the control of the three-phase inverter 134 (including Field Effect Transistors, such as power transistor switches 136). The control of the three-phase inverter 134 provides coordinated power (e.g., sinusoidal voltages to generate currents Ia, Ib, Ic) to the motor 28′ e.g. FETS 136 controlled as load switches to connect or disconnect a source of electrical energy or main power source 110 (voltage/current) as controlled by the controller 74 or a FET driver to control the motor 28′ in a manner as will be illustratively described below. Illustratively, the controller 74 is electrically directly or indirectly connected to the three-phase inverter 134 for control thereof (e.g. for controlling of FET switching rate). The three-phase inverter 134 is shown as illustratively connected to the motor 28′ via the three electrical lines 117a, 117b, 117c. Sensed current signals as well as back EMF voltage signals generated by the rotation of the rotor 113 may also be illustratively received by the controller 74 through the same electrical lines 117a, 117b, 117c and monitored by the current circuits 139 coupled to the motion trigger 140 of the microprocessor 133.

The controller 74 is configured to implement a Field Oriented Control (FOC) method or algorithm as stored in memory 138 as instructions and as executed by the controller 74, for controlling the brushless electric motor 28′. With FOC (or Vector Control) brushless motor techniques, as described herein, the torque and the flux can be controlled independently for braking to control the force moving the window 20, as well as improving motor starting, improving motor stopping, and improving motor reversing.

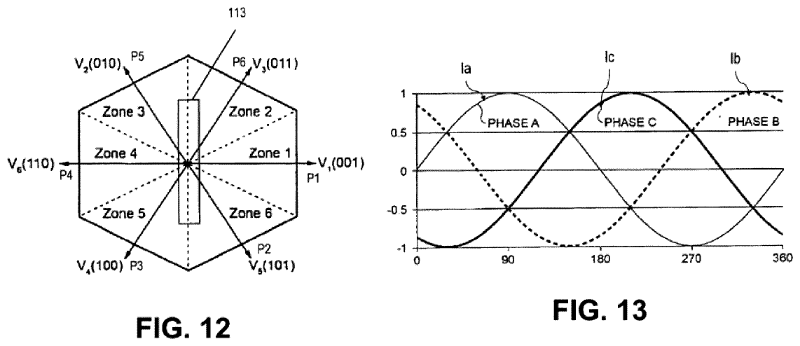

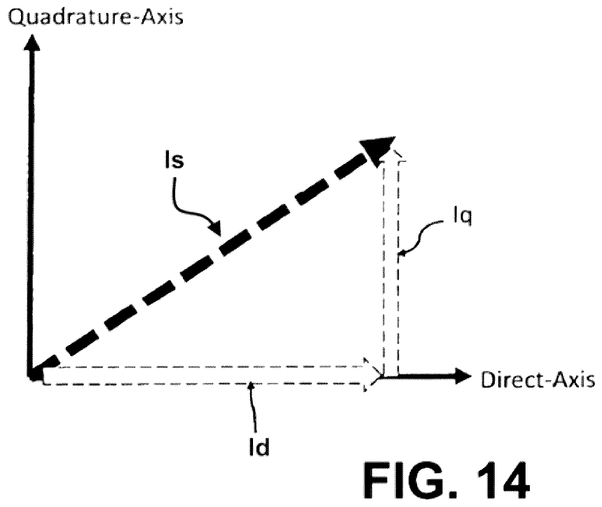

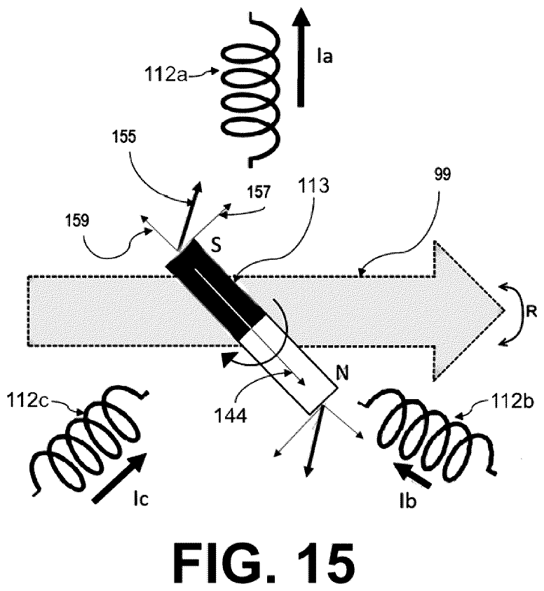

Referring now to FIGS. 14-18, the Field Oriented Control brushless motor technique optimize the torque generated by the rotor 113 over the angles of rotation of the rotor 113 relative to the windings 112a, 112b, 112c. The commutated currents Ia, Ib, Ic supplied to the windings 112a, 112b, 112c will generate a stator field 99 that is targeted to be orthogonal to the field of the rotor 113. The optimal direction of the net stator field force 155 to maximize torque of the rotor 113 rotation is illustrated as arrow 157 which acts to rotate the rotor 113. The sub-optimal direction of the net stator field force 155 is illustrated as arrow 159 which acts to outwardly pull on the rotor 113 and will generate no rotational torque on the rotor 113. When magnetic fields 99 and field 144 are parallel, the net stator field force 155 will only include the net stator field force 155 component as indicated by arrow 159, and therefore no torque is produced on the rotor 113. When magnetic fields 99 and field 144 are orthogonal, the net stator field force 155 will only include the net stator field force 155 component as indicated by arrow 157, and therefore maximum torque is produced on the rotor 113. Field Oriented Control (or Vector Control) targets to eliminate (e.g., 0) the pulling force 159 to maximize the torque force 157.

In order to maximize the torque in such a manner, the currents Ia, Ib, Ic, and voltages applied to the windings 112a, 112b, 112c are controlled separately and as a function of the actual angular position θ of the rotor 113 relative to the windings 112a, 112b, 112c, in order to align the stator field 99 in an orthogonal orientation with the rotor magnetic field 144. The phase shifted resultant stator current Is can be mathematically decomposed into two components as illustrated in FIGS. 14-16: a Quadrature current (Iq), or also referred to as torque current, which induces in the rotor 113 rotation according to the orthogonal force 157 acting on the rotor 113; and a Direct current (Id), or also referred to as flux current which induces the outward pulling force 159 on the rotor 113. The Field Oriented Control technique is concerned with adjusting these 2-axis domain components Id, Iq which are transformed using a transform function into the stator 3-axis domain as the three current signals Ia, Ib, Ic in order to reduce or eliminate the flux current Id to nil, leaving only the torque current Iq to generate the stator magnetic field 99 in quadrature with the rotor's quadrature axis as shown by arrow 157. By adjusting the supplied motor currents and voltages with reference to the rotor's flux or direct and quadrature axes, precise control of the rotor rotation results, such as decreases or increases in the rotor rotation can be precisely and quickly controlled since the torque current (Iq) can be adjusted based on the position θ of the rotor 113 which remains synchronized during rotation, which may be exactly determined by the use of the Hall sensor signals as will be described herein below. FOC control can therefore provide faster dynamic response than compared with brushed motor control, for example those using trapezoidal commutated control since the torque current Iq is calculated based on the exact position of the rotor 113. Faster motor response times are desirable for window regulator applications.

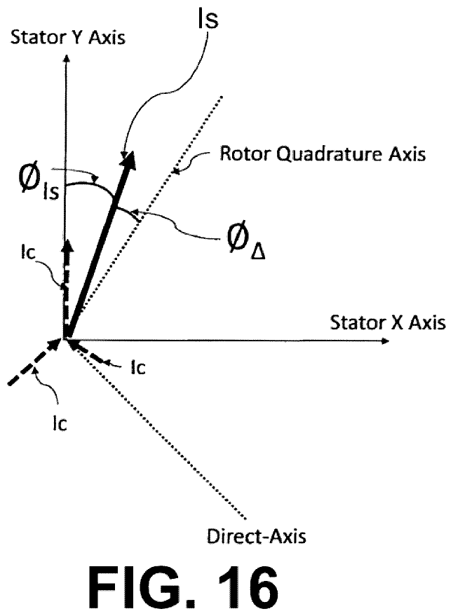

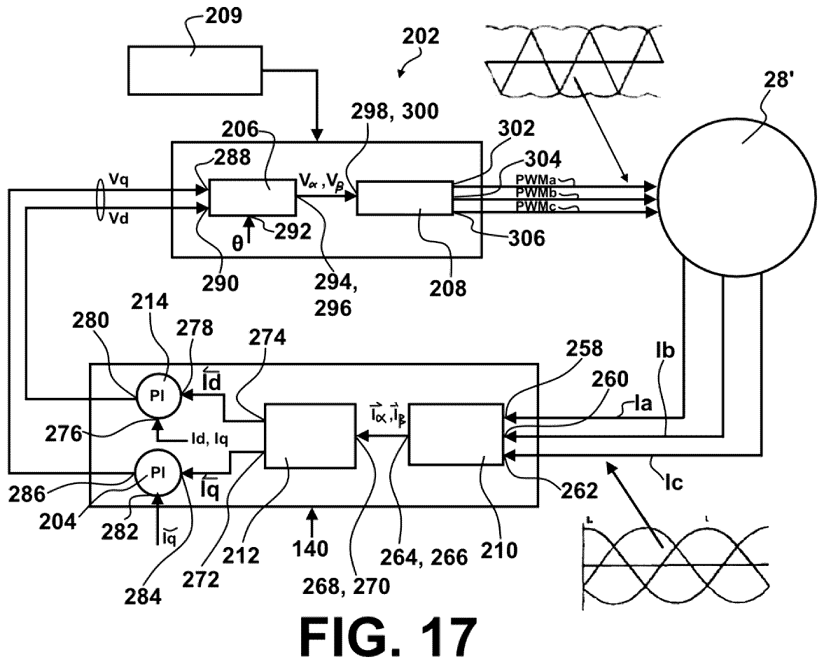

As best shown in FIG. 17, modules or units of the vector control system 202 of the controller 74 are provided to implement the field oriented and thus may be embodied in software as instructions stored in memory unit 138 as executed by the controller 74. The vector control system 202 is configured to receive a target torque current Ĭq based on an actual angular velocity ω of the brushless electric motor 28′ (e.g., determined using Hall sensors 114a, 114b, 114c of FIG. 11, as described in more detail below) and a sensed first phase current Ia and a second phase current Ib and a third phase current Ic from the brushless electric motor 28′ (e.g., currents flowing through windings/coils 112a, 112b, 112c, which may include current components induced as a result of the rotation of the rotor 113 in addition to currents supplied to the windings/coils 112a, 112b, 112c and sensed using an analog to digital converter). The vector control system 202 is also configured to determine an alpha stationary reference frame voltage [symbol] α and a beta stationary reference frame voltage based \hat{V}β based on the sensed first phase current Ia, second phase current Ib, and third phase current Ic in response to a Hall sensor or motion trigger 140 (rising edge or falling edge) based on a plurality of Hall sensor signals from the plurality of Hall sensors 114a, 114b, 114c. For example, the Hall sensor signals can be received by an interrupt handler 141 (FIG. 18) at an interrupt port of the controller 74. So, the torque voltage command \hat{V}q and the flux linkage voltage command \hat{V}d are updated once the Hall sensor or motion trigger 140 detected.

Consequently, the torque FOC vector (Vd, Vq) is calculated based on the exact known position of the rotor 113 and moment to maximize torque applied to the rotor 113. This torque calculation is only done six times per revolution at each Hall detection (e.g., if three Hall sensors 114a, 114b, 114c provided), compared to resolvers where calculations occur thousands of times per revolution. As a result, vector control system 202 uses the digital signals of the Hall sensors 114a, 114b, 114c to provide high accuracy of position θ of the rotor 113 which a resolver analog signal does not provide, and the FOC calculations are computationally less demanding resulting in quicker calculations and response times, a more efficient torque vector (Vd, Vq), as well as less expensive CPUs and processors.

The vector control system 202 maintains the alpha stationary reference frame voltage [symbol] α and the beta stationary reference frame voltage \hat{V}β. In addition, the vector control system 202 is configured to output a first phase pulse width modulation signal PWMa and a second phase pulse width modulation signal PWMb and a third phase pulse width modulation signal PWMc to the brushless electric motor 28 based on the alpha stationary reference frame voltage [symbol] α and the beta stationary reference frame voltage \hat{V}β. In more detail, the vector control system 202 includes a first proportional-integral control unit 204 configured to receive the target torque current Ĭq based on the actual angular velocity ω of the brushless electric motor 28 and a torque current drawn [symbol] q and output a torque voltage command \hat{V}q using the target torque current Ĭq the torque current drawn [symbol] q. An inverse Park transformation unit 206 is coupled to the first proportional-integral control unit 204 and is configured to receive an actual angular position θ of the brushless electric motor 28 and transform the torque voltage command \hat{V}q and a flux linkage voltage command \hat{V}d to an alpha stationary reference frame voltage \hat{V}α and a beta stationary reference frame voltage \hat{V}β using an inverse Park transformation. A switching states or space vector pulse width modulation unit 208 is coupled to the inverse Park transformation unit 206 and to the brushless electric motor 28 and is configured to convert the alpha stationary reference frame voltage \hat{V}α and a beta stationary reference frame voltage \hat{V}β to 3-phase stator reference signals and determine and output a first phase pulse width modulation signal PWMa and a second phase pulse width modulation signal PWMb and a third phase pulse width modulation signal PWMc to the brushless electric motor 28′. The switching states vector pulse width modulation unit 208 performs a space vector pulse width modulation calculation based on magnitudes of the calculated torque voltage command \hat{V}q and the flux linkage voltage command \hat{V}d when triggered by the motion trigger 140 (rising or falling edges of digital signals from the Hall sensors 114a, 114b, 114c) and the torque voltage command Vq and the flux linkage voltage command \hat{V}d are transformed based on the angle of rotor 113 over the sector of the rotation of the rotor 113. Both the switching states or space vector pulse width modulation unit 208 and the inverse Park transformation unit 206 are also coupled to and triggered by a pulse width modulation (PWM) trigger 209.

The vector control system 202 also includes a Clarke transformation unit 210 coupled to the brushless electric motor 28′ that is configured to receive the first phase current Ia and the second phase current Ib and the third phase current Ic from the brushless electric motor 28′ and determine and output an alpha stationary reference frame current [symbol] α and a beta stationary reference frame current [symbol] β using a Clarke transformation (e.g., the Clarke transformation will convert the balanced three-phase currents sensed from the 3-axis system of the windings 112a, 112b, 112c, into two-phase quadrature stator currents of a 2-axis coordinate system). A Park transformation unit 212 is coupled to the Clarke transformation unit 210 and is configured to receive the alpha stationary reference frame current [symbol] α and the beta stationary reference frame current [symbol] β and determine and output the torque current drawn [symbol] q and a field flux linkage current drawn [symbol] d using a Park transformation.

A second proportional-integral control unit 214 is coupled to the inverse Park transformation unit 206 and the Park transformation unit 212 and is configured to receive a reference flux linkage current [symbol] d_{ref} and the flux linkage current drawn [symbol] d and determine and output the flux linkage voltage command \hat{V}d to the inverse Park transformation unit 206.

Referring back to the vector control system 202, the Clarke transformation unit 210 has a first phase current input 258 and a second phase current input 260 and a third phase current input 262 each coupled to the brushless electric motor 28′ for receiving the first phase current Ia and the second phase current Ib and the third phase current Ic and an alpha stationary reference frame current output 264 coupled to the Park transformation unit 212 for outputting the alpha stationary reference frame current [symbol] α and a beta stationary reference frame current output 266 coupled to the Park transformation unit 212 for outputting the beta stationary reference frame current [symbol] β.

The Park transformation unit 212 has an alpha stationary reference frame current input 268 coupled to the alpha stationary reference frame current output 264 of the Clarke transformation unit 210 for receiving the alpha stationary reference frame current [symbol] α and a beta stationary reference frame current input 270 coupled to the beta stationary reference frame current output 266 of the Clarke transformation unit 210 for receiving the beta stationary reference frame current [symbol] β. The Park transformation unit 212 also has a torque current drawn output 272 coupled to the first proportional-integral control unit 204 for outputting the torque current drawn torque current drawn [symbol] q and a field flux linkage current drawn output 274 coupled to the second proportional-integral control unit 214 for outputting the field flux current drawn [symbol] d.

The second proportional-integral control unit 214 has a second reference input 276 being the reference flux linkage current [symbol] d_{reference} (e.g., reference flux linkage current=0 for reasons as described herein above to eliminate the force acting on the rotor 113 depicted by arrow 159) and a second measured input 278 coupled to the flux linkage current drawn output 274 of the Park transformation unit 212 for receiving the flux linkage current drawn [symbol] d and a flux linkage voltage output 280 coupled to the inverse Park transformation unit 206 for outputting the flux linkage voltage command \hat{V}d.

The first proportional-integral control unit 204 has a first reference input 282 for receiving the target or desired torque current Ĭq. The first proportional-integral control unit 204 also has a first measured input 284 coupled to the torque current drawn output 272 for receiving the torque current drawn [symbol] q and a torque voltage output 286 coupled to the inverse Park transformation unit 206 for outputting the torque voltage command \hat{V}q. It is hereby recognized that control system 200 takes advantage of the inherent properties of the brushless electric motor 28′, specifically the property that when the brushless electric motor 28′ is slowed, for example by a pinch event, the torque current drawn [symbol] q will increase. The PI integration of the difference between the limited torque current Ĭq and this inherently increased torque current drawn [symbol] q as represented in FIG. 18 by arrow F will result in a lowered torque voltage command \hat{V}q to be applied to the motor 28′, thus further reducing measured angular velocity ω and inertia in the actuation system 27. So, the Hall sensors 114a, 114b, 114c detect the position of the rotor 113, as shown and the microcontroller 133 calculates the flux linkage voltage command \hat{V}d and torque voltage command \hat{V}q to eliminate the direct or flux current Id, such that only the perpendicular force F on the rotor 113 will result (e.g., maximum torque on the rotor 113 applied by the filed generated in the coils 112a, 112b, 112c by the transformed flux linkage voltage command \hat{V}d and torque voltage command \hat{V}q).

The inverse Park transformation unit 206 has a first inverse Park input 288 coupled to the torque voltage output 286 of the first proportional-integral control unit 204 for receiving the torque voltage command \hat{V}q. The inverse Park transformation unit 206 additionally has a second inverse Park input 290 coupled to the flux linkage voltage output 280 of the second proportional-integral control unit 214 for receiving the flux linkage voltage command \hat{V}d and a third inverse Park input 292 coupled to the adder output 252 of the adder unit 246 of the position determining system 216 for receiving the actual angular position θ (or estimated angle of rotor 13). The inverse Park transformation unit 206 also has an alpha stationary reference frame voltage output 294 coupled to the switching states vector pulse width modulation unit 208 for outputting the alpha stationary reference frame voltage \hat{V}α and a beta stationary reference frame voltage output 296 coupled to the switching states vector pulse width modulation unit 208 for outputting the alpha stationary reference frame voltage \hat{V}β.

The switching states vector pulse width modulation unit 208 converts the two component alpha stationary reference frame voltage \hat{V}α and the beta stationary reference frame voltage \hat{V}β into the three component stator domain to generate the PWM signals to be supplied to each stator winding 112a, 112b, 112c. The switching states vector pulse width modulation unit 208 has an alpha stationary reference frame voltage input 298 coupled to the alpha stationary reference frame voltage output 294 of the inverse Park transformation unit 206 for receiving the alpha stationary reference frame voltage \hat{V}α and a beta stationary reference frame voltage input 300 coupled to the beta stationary reference frame voltage output 296 of the inverse Park transformation unit 206 for receiving the beta stationary reference frame voltage \hat{V}β. The switching states vector pulse width modulation unit 208 also has a first phase pulse width modulation output 302 coupled to the brushless electric motor 28 (e.g., to winding 112a) for outputting the first phase pulse modulation signal PWMa and a second phase pulse width modulation output 304 coupled to the brushless electric motor 28 (e.g. to winding 112b) for outputting the second phase pulse modulation signal PWMb and a third phase pulse width modulation output 306 coupled to the brushless electric motor 28 (e.g. to winding 112c) for outputting the third phase pulse width modulation signal PWMc.

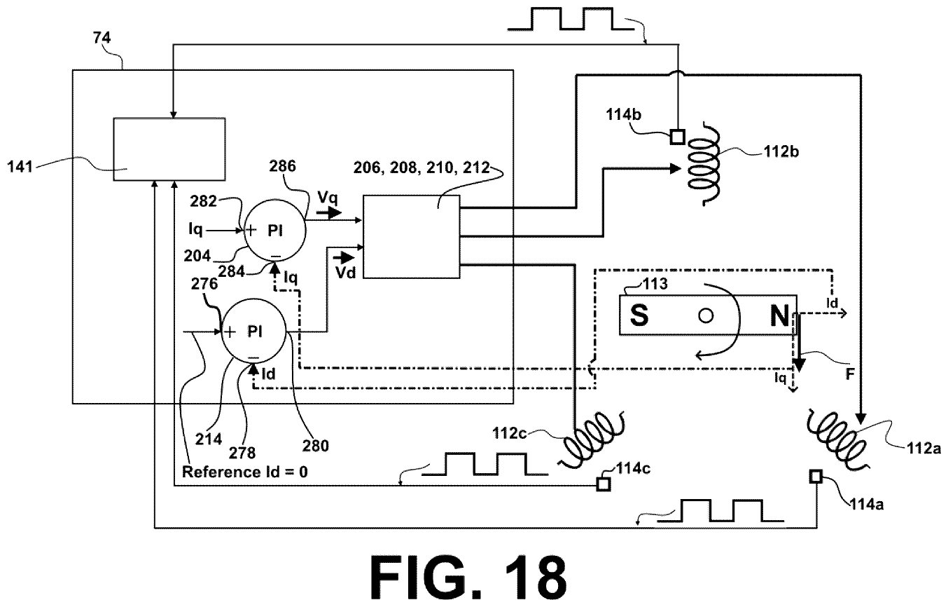

In FIG. 19A, a manual input movement is applied to the window 20, thereby causing a slight movement of the motor 28′ (and rotor 113). In FIG. 19B, the rotor and stator fields 99, 144 are slightly out of alignment (e.g., the manual movement is just starting to move the rotor 113) by θ₁. As shown in FIG. 19C, the flux linkage current drawn [symbol] d is insufficient to resist rotor rotation and the flux linkage current drawn [symbol] d drops and torque current Iq is induced in the rotor 113, naturally opposing the direction of the rotor 113. So, a generated torque current 307 is opposite to the induced torque current Iq bringing the rotor 113 back into alignment. The at least one sensor (e.g., Hall sensors 114a, 114b, 114c) shown in FIG. 19B is not triggered yet due to movement of the rotor 113.

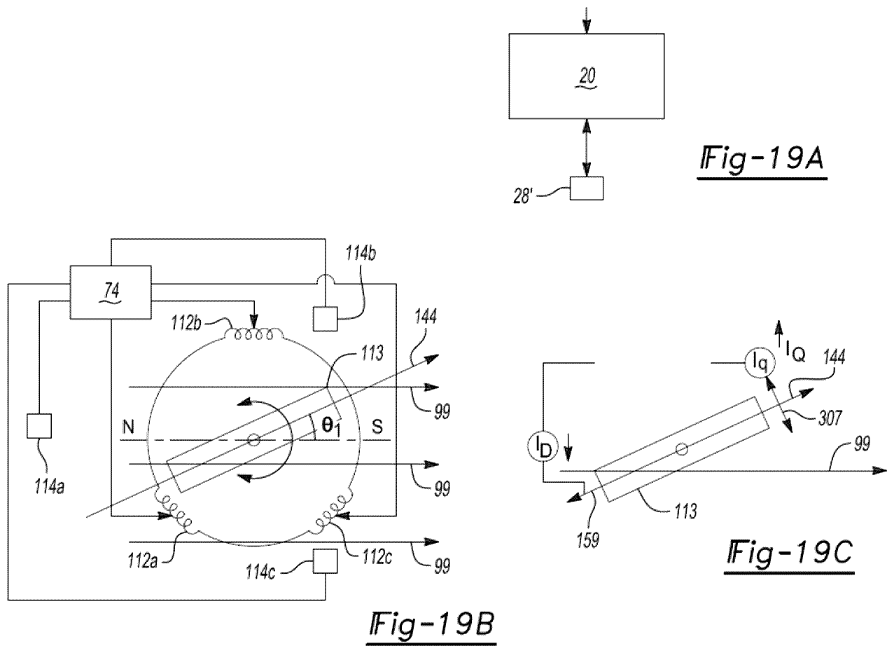

However, an increased manual input movement can be applied to the window 20 resulting in braking or resisting of the motor 28′ as shown in FIG. 20A. Such a resisting mode is utilized once the rotor and stator fields 99, 144 are out of alignment by θ₂ (a larger angle than θ₁), as shown in FIG. 20B. The controller 74 is configured to detect the sensor signal from the at least one sensor (e.g. Hall effect sensors 114a, 114b, 114c) triggering the motion trigger 140 and indicating a manual movement of the shaft 72 of the motor 28′ in the back drive state. The controller 74 also monitors the first phase current Ia and the second phase current Ib and the third phase current Ic from the motor 28′ in the back drive state. The controller 74 is also configured to calculate a torque current drawn [symbol] q and a field flux linkage current drawn [symbol] d based on the first phase current Ia and the second phase current Ib and the third phase current Ic from the motor 28′ in response to detecting the sensor signal from the at least one sensor 114a, 114b, 114c indicating the manual movement of the shaft 72 of the motor 28′ in the back drive state.

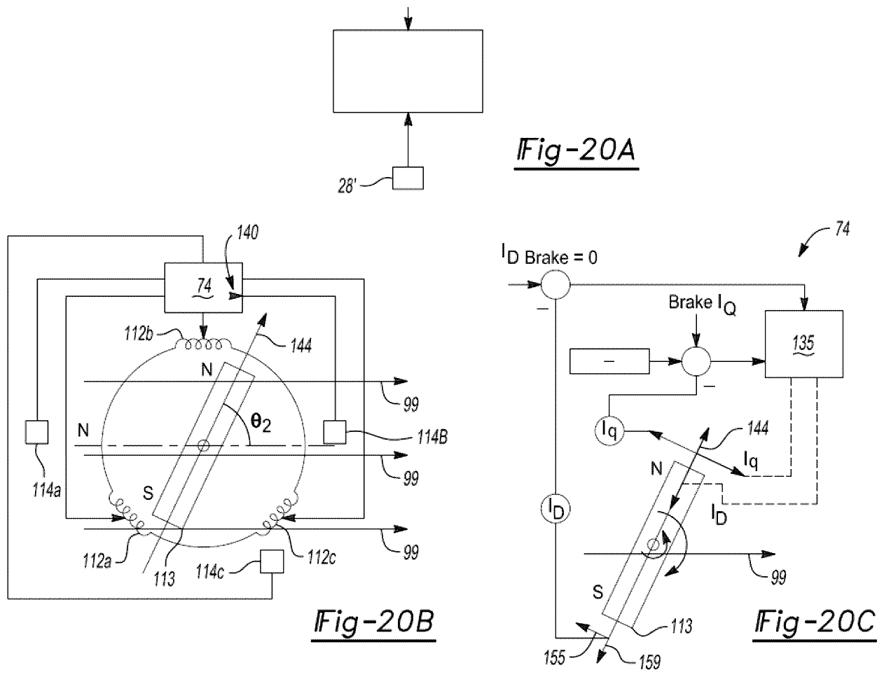

The controller 74 then generates a flux linkage voltage command \hat{V}d and a torque voltage command \hat{V}q resulting in an opposing torque current opposite the torque current drawn [symbol] q and minimize the field flux linkage current drawn [symbol] d in a resisting mode of the back drive state, as best shown in FIG. 20C. The controller 74 can also generate the flux linkage voltage command \hat{V}d and the torque voltage command \hat{V}q resulting in the torque current drawn [symbol] q being minimized and the field flux linkage current drawn [symbol] d being maximized in a holding mode of the back drive state shown in FIGS. 21A and 21B.

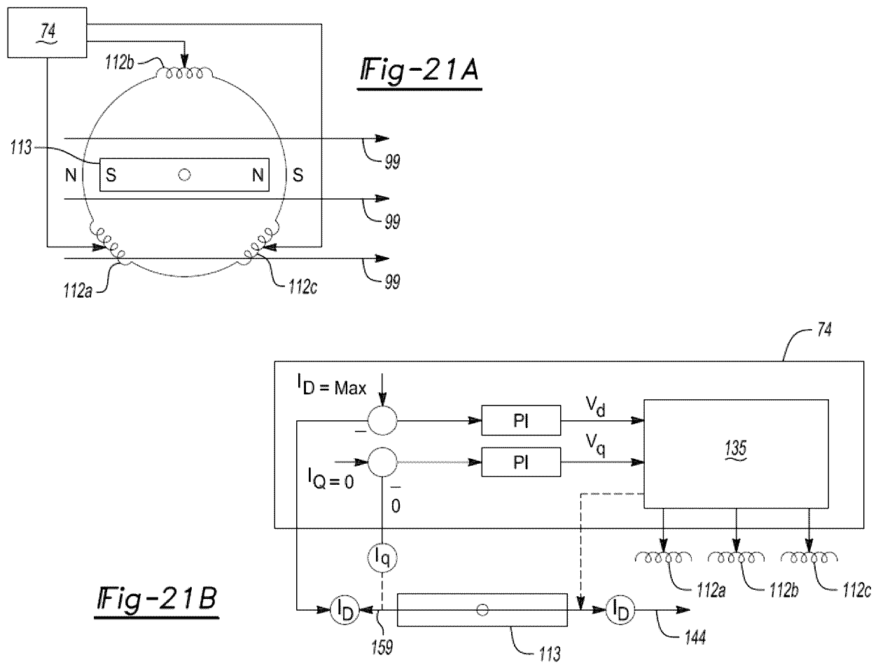

As best shown in FIGS. 22-25, a method of operating an actuation system 27 for moving a closure panel 20 of a vehicle 10 in one of a normal drive state and a back drive state is also provided. The method includes the steps of detecting a motor movement command using a controller 74 in the normal drive state. Next, the method includes the step of directly moving the closure panel 20 in between an open position and a closed position with a motor 28, 28′ having a shaft 72 directly and operably connected to a mechanical coupling 70 connected to the closure panel 20 based on the motor movement command detected in the normal drive state. The method proceeds by detecting movement of the closure panel 20 using at least one sensor 114a, 114b, 114c coupled to the motor 28, 28′ and the controller 74 in one of the normal drive mode and the back drive state. The method continues with the step of controlling operation of the motor 28, 28′ using the controller 74 based on the movement detected and the motor movement command detected in one of the normal drive mode and the back drive state. The method continues with the step of selectively braking the movement of the closure panel 20 in between the closed position and the open position based on the movement detected using the controller 74 in the back drive state.

As discussed above, the motor 28, 28′ can be the brushless direct current electric motor 28′. Thus, as best shown in FIG. 22, the step of selectively braking the movement of the closure panel 20 in between the closed position and the open position based on the movement detected using the controller 74 in the back drive state can include steps of 400 determining whether the movement of the closure panel 20 is detected and 402 returning to a start braking step in response to not determining that the movement of the closure panel 20 is detected. The method can also include the step of 404 applying power to the brushless direct current electric motor 28′ to counter the movement of the closure panel 20 in response to determining that the movement of the closure panel 20 is detected. The method can continue with the steps of 406 waiting for a predetermined period of time (e.g., one second) and 408 returning to the step of 400 determining whether the movement of the closure panel 20 is detected after waiting for the predetermined period of time.

As discussed, the actuation system 27 can further include an electromechanical brake assembly 76 coupled to at least one of the mechanical coupling 70 and the motor 28, 28′ and electrically coupled to the controller 74. The electromechanical brake assembly 76 is controlled by the controller 74 to selectively move between an engaged status (in which rotation of the shaft 72 is hindered for braking movement of the mechanical coupling 70 and the closure panel 20 between the closed position and the open position in the back drive state) and a disengaged status (in which the shaft 72 is permitted to rotate and allow movement of the mechanical coupling 70 and the closure panel 20 in the normal drive state).

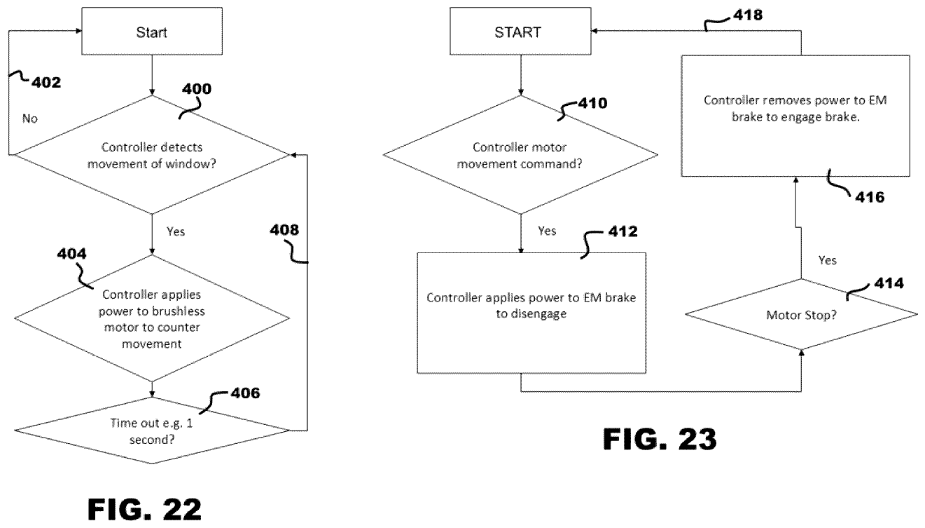

Consequently, as best shown in FIG. 23, the step of selectively braking the movement of the closure panel 20 in between the closed position and the open position based on the movement detected using the controller 74 in the back drive state can include the step of 410 determining whether the motor movement command is detected. The method can continue by 412 applying power to the electromechanical brake assembly 76 to transition the electromechanical brake assembly 76 to the disengaged status in response to determining that the motor movement command is detected. The method can proceed with the step of 414 determining that the movement of the closure panel 20 has stopped (e.g., the shaft 72 of the motor 28, 28′ has stopped rotating). The method can then include the step of 416 removing power from the electromechanical brake assembly 76 to transition the electromechanical brake assembly 76 to the engaged status in response to determining that the movement of the closure panel 20 has stopped. The method can continue with the step of 418 returning to a start braking step after removing power from the electromechanical brake assembly 76.

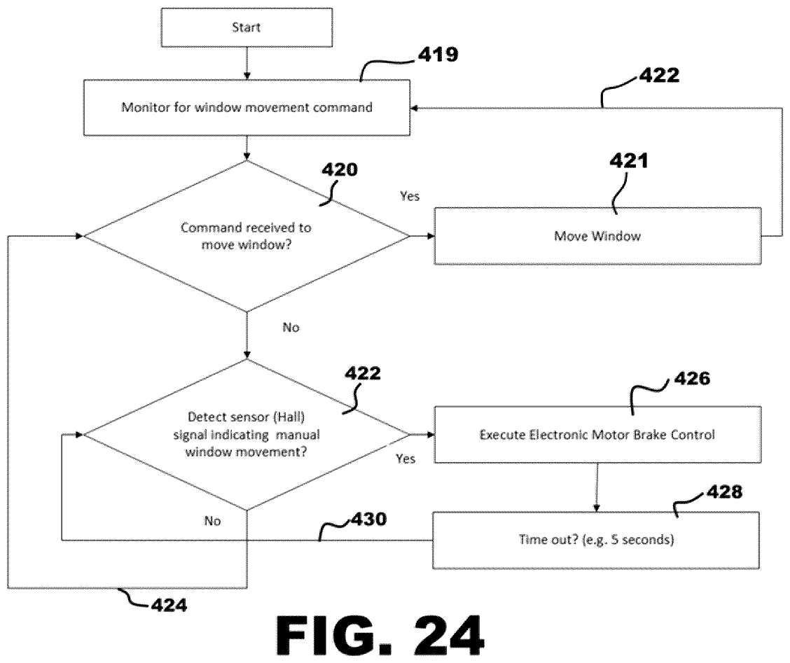

If, for example, the closure panel 20 is a window 20 of a door and the motor 28, 28′ is a brushless direct current electric motor 28′, the method can include steps shown in FIG. 24. Specifically, the method may further include the steps of 419 monitoring for the motor movement command and 420 determining whether the motor movement command is detected. Next, 421 moving the window 20 in response to determining the motor movement command is detected and 422 returning to the step of 419 monitoring for the motor movement command in response to determining the motor movement command is not detected. The method continues with the step of 423 detecting a sensor signal from the at least one sensor 114a, 114b, 114c indicating a manual movement of the window 20 in response to not determining that the motor movement command is detected. The method can then continue with the step of 424 returning to the step of 420 determining whether the motor movement command is detected in response to not detecting the sensor signal from the at least one sensor 114a, 114b, 114c indicating the manual movement of the window 20. The method can then include the step of 426 executing an electronic motor brake control in response to detecting the sensor signal from the at least one sensor 114a, 114b, 114c indicating the manual movement of the window 20. Next, the method can continue with the steps of 428 waiting for a predetermined period of time and 430 returning to the step of 422 detecting a sensor signal from the at least one sensor 114a, 114b, 114c indicating a manual movement of the window 20 after waiting for the predetermined period of time (such a step can help conserve electrical energy in a vehicle battery, so that the braking is not continuously on).

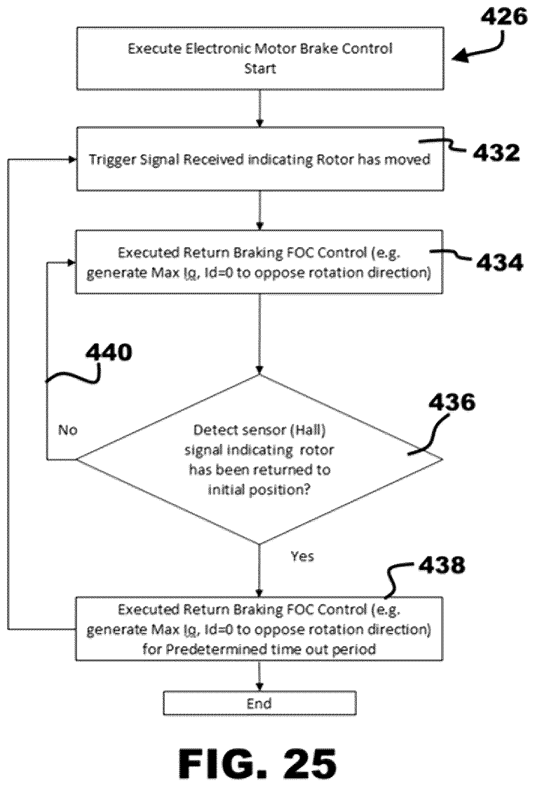

Referring to FIG. 25, the step of 426 executing the electronic motor brake control can include the step of 432 determining that the sensor signal from the at least one sensor 114a, 114b, 114c indicates the manual movement of the window 20. The method can then include the step of 434 executing return braking field oriented control in a resisting mode of the back drive state in response to determining that the sensor signal from the at least one sensor 114a, 114b, 114c indicates the manual movement of the window 20 (e.g., generate the flux linkage voltage command \hat{V}d and the torque voltage command \hat{V}q resulting in the torque current drawn [symbol] q being minimized and the field flux linkage current drawn [symbol] d being maximized to oppose rotation direction of the rotor 113). Step of 434 may be optional and the method can directly proceed to a resisting mode in step 434 upon triggering of the hall sensors Hall sensors 114a, 114b, 114c, for example.

More Specifically, the step of 434 executing return braking field oriented control in the resisting mode of the back drive state in response to determining that the sensor signal from the at least one sensor 114a, 114b, 114c indicates the manual movement of the window 20 can include the step of monitoring a first phase current Ia and a second phase current Ib and a third phase current Ic from the motor 28′ calculating a torque current drawn [symbol] q and a field flux linkage current drawn [symbol] d based on the first phase current Ia and the second phase current Ib and the third phase current Ic from the motor 28′ the generating a flux linkage voltage command \hat{V}d and a torque voltage command \hat{V}q resulting in an opposing torque current opposite the torque current drawn [symbol] q and minimize the field flux linkage current drawn [symbol] d.

Continuing to refer to FIG. 25, the next step of the method can be 436 determining whether the sensor signal indicates that the window 20 has moved back to an initial position. Then, the method can proceed by 438 executing return braking field oriented control in a holding mode of the back drive state (e.g., generate the flux linkage voltage command \hat{V}d and the torque voltage command \hat{V}q resulting in the torque current drawn [symbol] q being minimized and the field flux linkage current drawn [symbol] d being maximized to oppose rotation direction of the rotor 113 for a predetermined time out period of time) in response to determining that the sensor signal indicates that the window 20 has moved back to the initial position (such a step can help conserve electrical energy in a vehicle battery, so that the braking is not continuously on).

In more detail, the step of 438 executing return braking field oriented control in the holding mode of the back drive state in response to determining that the sensor signal indicates that the window 20 has moved back to the initial position can include the steps of monitoring a first phase current Ia and a second phase current Ib and a third phase current Ic from the motor 28′ and calculating a torque current drawn [symbol] q and a field flux linkage current drawn [symbol] d based on the first phase current Ia and the second phase current Ib and the third phase current Ic from the motor 28′. Next, generating the flux linkage voltage command \hat{V}d and the torque voltage command \hat{V}q resulting in the torque current drawn [symbol] q being minimized and the field flux linkage current drawn [symbol] d being maximized.

Still referring to FIG. 25, the method can also include the step of 440 returning to the step of 434 executing return braking field oriented control in a resisting mode of the back drive state in response to determining that the sensor signal indicates that the window 20 has not moved back to the initial position.

Clearly, changes may be made to what is described and illustrated herein without, however, departing from the scope defined in the accompanying claims. The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

As discussed above, the actuation system 27 disclosed herein can be applied to window regulators. Other actuation applications are also contemplated. Although one exemplary operation of resisting and holding of a brushless motor using FOC control is provided, other manners of resisting and holding the rotor of the brushless motor may be provided, for example using a FOC technique with a resolver. Those skilled in the art will recognize that concepts disclosed in association with the example actuation system 27 can likewise be implemented into many other systems to control one or more operations and/or functions, such as, but not limited to other closure panels including doors and lift gates.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

What is claimed is:

1. An actuation system for moving a closure panel of a vehicle, comprising:
a mechanical coupling connected to the closure panel for moving the closure panel in between an open position and a closed position; and
a motor having a shaft directly and operably connected to the mechanical coupling and configured to directly move the mechanical coupling.

2. The actuation system as set forth in claim 1, wherein a gear reduction mechanism is not interconnected between the shaft and the mechanical coupling.

3. The actuation system as set forth in claim 1, wherein a clutch mechanism is not interconnected between the shaft and the mechanical coupling.

4. The actuation system as set forth in claim 1, wherein the motor is a brushless motor.

5. The actuation system as set forth in claim 1, wherein the shaft is interconnected to the mechanical coupling by a transmission.

6. The actuation system as set forth in claim 5, wherein the transmission is a backdrivable transmission.

7. The actuation system as set forth in claim 5, further comprising:
a cable operably connected to the mechanical coupling;
a drum operably coupled to the shaft of the motor with the cable looped about the drum for moving the cable and the mechanical coupling in response to rotation of the shaft of the motor.

8. The actuation system as set forth in claim 7, wherein the mechanical coupling is a lifter plate, and the closure panel is a window.

9. The actuation system as set forth in claim 7, wherein the mechanical coupling is a sliding door bracket, and the closure panel is a sliding door.

10. The actuation system as set forth in claim 5, further comprising a braking system coupled to at least one of the mechanical coupling and the transmission and the motor.

11. The actuation system as set forth in claim 10, wherein the braking system comprises a braking assembly configured for selectively braking the movement of the closure panel, the at least one of the mechanical coupling and the transmission and the motor.

12. The actuation system as set forth in claim 10, wherein the braking system comprises:
at least one sensor for detecting movement of at least one of the closure panel, the mechanical coupling, the transmission, and the motor; and
a controller electrically coupled to the motor and to the at least one sensor and configured to detect movement of the at least one of the closure panel, the mechanical coupling, the transmission, and the motor using the at least one sensor and to selectively brake the movement of the closure panel in between the closed position and the open position based on the detected movement.

13. The actuation system as set forth in claim 12, wherein the controller is configured control the motor to oppose the detected movement of the at least one of the closure panel, the mechanical coupling, the transmission, and the motor.

14. The actuation system as set forth in claim 13, wherein the motor is a brushless motor and the controller is configured to control the motor using a field oriented control methodology comprising supplying a flux linkage voltage command and a torque voltage command to the motor.

15. The actuation system as set forth in claim 1, wherein the closure panel is a window of a door and the mechanical coupling includes:
a rail for coupling to the door;
a lifter plate attached to the window and slidably mounted on the rail;
a cable attached to the lifter plate;
a drum directly coupled to the shaft of the motor with the cable looped about the drum for moving the cable and the lifter plate along the rail in response to rotation of the shaft of the motor.

16. The actuation system as set forth in claim 1, wherein the closure panel is a window of a door and the mechanical coupling includes:
a rail for coupling to the door;
a cable directly driven by the shaft of the motor;
a lifter plate attached to the window and slidably mounted on the rail and configured to lock the lifter plate at any position along the rail when the motor is not operated and the cable is not tensioned by the motor, and for enabling motion of the lifter plate when the motor is operated and the cable is tensioned by the motor.

17. The actuation system as set forth in claim 1, wherein the closure panel is a window of a door and the mechanical coupling includes:
a rail for coupling to the door;
a lifter plate attached to the window and slidably mounted on the rail;
a cable attached to the lifter plate;
a gear train being back drivable and having a gear train input driven by the shaft of the motor and a gear train output; and
a drum coupled to the gear train output with the cable looped thereabout for moving the cable and the lifter plate along the rail in response to rotation of the shaft of the motor as modified by the gear train.

18. A method of operating an actuation system for moving a closure panel of a vehicle in one of a normal drive mode and a back drive mode comprising the steps of:
detecting a motor movement command using a controller in the normal drive mode;
directly moving the closure panel in between an open position and a closed position with a motor having a shaft directly and operably connected to a mechanical coupling connected to the closure panel based on the motor movement command detected in the normal drive mode;
detecting movement of the closure panel using at least one sensor coupled to the motor and the controller in one of the normal drive mode and the back drive mode;
controlling operation of the motor using the controller based on the movement detected and the motor movement command detected in one of the normal drive mode and the back drive mode; and
selectively braking the movement of the closure panel in between the closed position and the open position based on the movement detected using the controller in the back drive mode.

19. A method of constructing an actuation system for moving a closure panel of a vehicle comprising the steps of:
providing a mechanical coupling connected to the closure panel for moving the closure panel in between an open position and a closed position; and
providing a motor having a shaft directly and operably connected to the mechanical coupling and configured to directly move the mechanical coupling.

20. The method of claim 19, further comprising interconnecting the shaft to the mechanical coupling using a transmission, wherein the transmission is backdriveable.
